(19) United States
(12) Patent Application Publication
(10) Pub. No.: US 2018/0208707 A1
(43) Pub. Date: Jul. 26, 2018

(54) PRODUCTION OF POLYURETHANE SOFT FOAMS WITH IMPROVED HARDNESS

(71) Applicant: Evonik Degussa GmbH, Essen (DE)

(72) Inventors: Michael Krebs, Düsseldorf (DE); Jens Sassenhagen, Essen (DE); Roland Hubel, Essen (DE); Maike Funk, Dorsten (DE)

(21) Appl. No.: 15/745,797

(22) PCT Filed: Jul. 20, 2016
(86) PCT No.: PCT/EP2016/067241

§ 371 Date: Jan. 18, 2018

(30) Foreign Application Priority Data
Aug. 17, 2015 (EP) 15181218.7

(51) Int. Cl. C08G 18/48; C08G 18/18; C08G 18/24; C08G 18/76

(52) U.S. Cl. CPC C08G 18/4841; C08G 18/4816; C08G 18/18; C08G 2101/0008; C08G 18/4837; C08G 18/7621; C08G 18/244

(57) ABSTRACT

The invention relates to an additive suitable for increasing compressive strength during the production of polyurethane soft foam, which contains at least one compound (V) containing, (i) more than three hydrogen atoms which are reactive with respect to isocyanates, (ii) an average hydroxyl number, determined according to DIN 53240-1: 2013-06, from 110-280 mg KOH/g, preferably 120-250 mg KOH/g, and (iv) >50 wt.-% ethylene oxide bound in the molecule, wt.-% with respect to the total alkylene oxide, and to a method for producing polyurethane foams and to a polyurethane foam and to the use thereof as described.

The present invention is in the field of polyurethanes. It especially relates to flexible polyurethane systems and to a process for producing such polyurethane systems using particular crosslinkers to increase hardness.

A variety of different polyurethanes are typically prepared by the polymerization of diisocyanates, for example 4,4′-methylenebis(phenyl isocyanate), MDI for short, or tolylene 2,4-diisocyanate, TDI for short, with polyether polyols or polyester polyols. Polyether polyols can be produced, for example, by alkoxylation of polyhydroxy-functional starters. Commonly used starters are, for example, glycols, glycerol, trimethylolpropane, pentaerythritol, sorbitol or sucrose. In the production of polyurethane foams, one of the most important polyurethane systems, additional blowing agents are typically used, examples being pentane, methylene chloride, acetone or carbon dioxide. Water is usually used as chemical blowing agent, which reacts with isocyanate to give a polyurea with elimination of carbon dioxide. Typically, the polyurethane foam is stabilized using surface-active substances, especially silicone surfactants.

Polyurethane foams have outstanding mechanical and physical properties and so are used in a very wide variety of fields. The automotive and furniture industries are a particularly important market for a wide variety of types of PU foam, such as conventional flexible foams based on ether and ester polyols, cold-cure foams (frequently also referred to as HR foams), rigid foams, integral foams and microcellular foams and also foams with properties between these classifications, for example semi-rigid systems. For example, cold-cure and flexible foams are used for seating systems and mattresses.

Other relevant polyurethane systems are, for example, polyurethane coatings, polyurethane adhesives, polyurethane sealants or polyurethane elastomers.

In many parts of the world, the market is demanding means of increasing hardness of flexible polyurethane foams. For example, in Africa and south-east Asia, the comfort of a mattress or piece of seating furniture is considered to increase with its hardness. However, an increase in hardness is generally not directly possible, at least not without accepting a usually unwanted change in other physical properties of the mattress or piece of seating furniture. Hardness can be increased in flexible polyurethane foams by various means known in the prior art. Hardness can be determined in the context of the present invention either as what is called the compressive strength to DIN EN ISO 3386-1:1997+A1:2010 or as the indentation hardness to DIN EN ISO 2439:2008. To determine the compressive strength, a square test specimen is compressed between two plates and the force needed to compress this test specimen to a particular magnitude of its original height (e.g. 25%, 40% or 65%) is measured. This value is then expressed in relation to the area tested to give the compressive strength or the compression resistance of the foam in kPa. In contrast with the compressive strength, where the compression plates are larger than the test specimen, the indentation hardness or crush resistance is ascertained with smaller compression plates that are rounded off to avoid excessive shear. In this case, the foam is crushed by 25%, 40% and 65% of the starting thickness and then the indentation hardness or the crush resistance is reported in N.

A general observation is that flexible polyurethane foams of elevated foam density also have elevated compressive strength. However, a drawback of this is that production of foams of increased foam density requires a greater amount of raw materials, which makes the production of the foams less economically viable. The use of polymer polyol, for example SAN, PHD or PIPA polyols, likewise leads to a distinct increase in hardness of the foams. In this case, the polyether polyol required for production of the flexible foam is partly replaced by polymer polyol. It is also the case that a relatively small use amount of the polymer polyol leads only to a relatively small increase in hardness. Use of below 10 wt % thus leads to a negligible increase in hardness, and so, according to the polymer content in the polymer polyol and the desired hardness level of the polyurethane foam, usually between 10 wt % and 100 wt % of the polyether polyol required for the production of the foam is replaced by polymer polyol. Since the cost of the polymer polyol required usually very clearly exceeds the cost of the polyether polyol used as standard, this process has the drawback of being very costly.

Flexible polyurethane foams having improved hardness can thus be produced only with considerable extra financial investment. Moreover, polyurethane foams produced with styrene/acrylonitrile (SAN) copolymer polyol generally have poor emission characteristics, ascertained, for example, in accordance with the test chamber method based on DIN standard DIN EN ISO 16000-9:2008-04, 24 hours after test chamber loading. Further drawbacks of the method described above are also the increase in density of the polyurethane foam induced by the polymer content in the polyol and the poor availability of polymer polyol in particular regions of the world.

One means of increasing hardness of a flexible polyurethane foam at constant foam density is to increase the degree of crosslinking in the foam network. This can in turn be achieved by various measures. First of all, it is possible to increase the isocyanate index. The isocyanate index is an index firmly established in the field of polyurethanes and describes the ratio of isocyanate actually used to calculated isocyanate (for a stoichiometric reaction with polyol, water and other compounds reactive toward isocyanates), multiplied by 100. An index of 100 represents a molar ratio of 1:1 for the reactive groups. The index for the production of flexible slabstock foam is normally between 95 and 115, or else lower if the foams are viscoelastic. However, an increase in the index can have several serious drawbacks as well as the desired increase in hardness. Thus, an increase in the crosslinking level generally leads to a lower air permeability or an increased closed cell content of the foams. Moreover, an increased amount of isocyanate has the drawback that the exothermicity of the foaming process is increased and hence a higher core temperature in the foam is attained. This can lead to core discoloration (called “scorch”) or in the extreme case to spontaneous self-ignition of the foam block. A greater amount of isocyanate also always means extra financial investment for the foaming processor. An undesirably increased closed cell content is also obtained when the amount of tin catalyst is increased for better crosslinking and hence for increasing hardness. A further means of enhancing crosslinking and hence increasing the hardness of the flexible foam lies in the use of crosslinkers. Crosslinkers are additives which are usually high-functionality isocyanate-reactive compounds. Experience has shown, however, that use of crosslinkers always also leads to an increased closed cell content, which is undesirable. This is balanced out in many cases by the (at least partial) use of TDI-65 (as described, for example, in DE 3630225) or by the additional use of cell opener additives (as described, for example, in EP 0 637 605 or WO 2014/120191). TDI-65 is a mixture of 65% toluene 2,4-diisocyanate and 35% toluene 2,6-diisocyanate. It is used as a less reactive isocyanate mixture (compared to the standard TDI-80, which consists of 80% toluene 2,4-diisocyanate and 20% toluene 2,6-diisocyanate) for opening of the cells in closed flexible polyurethane foam formulations. In both cases, both in the case of use of TDI-65 and in the case of use of cell opener additives, the foaming processor has to use and install additional raw material lines, since neither component can be processed directly in raw material containers for the usual reactants. This in turn leads to considerable extra financial investment for the foam-producing industry.

A high closed cell content is undesirable for several reasons in the case of mattresses and cushioned furniture. A high proportion of closed cells causes a mattress to lose a high proportion of its breathability, meaning that water cannot be absorbed by the mattress and hence cannot be transported away either. In the night, the human body releases moisture in the form of perspiration and/or perspiration vapour to its environment (at least about 0.7 l of water per night according to the climate). In order to prevent sweating, it is therefore very important that the mattress materials allow the liquid and/or vapours to diffuse or can channel them away and hence conduct them away from the body. This gives rise to a dry and pleasant bed environment. If the materials, in contrast, are not breathable, the material does not channel moisture away and/or is not vapour-permeable, and so there is an unacceptable drop in sleeping comfort. A further serious drawback of an excessively high closed cell content is a lower expected lifetime of the piece of seating furniture or the mattress. As a result of frequent use, the cells of the flexible polyurethane foam are crushed under the action of human weight. This causes the foam to lose hardness and the compression set to increase. This leads to unwanted hollows. Hollows are depressions which are able at best after a while or are even not able at all to return to the starting state, since the required resilience has been lost.

Moreover, foams having an elevated closed cell content have reduced elasticity, which can in turn have an adverse effect on the comfort of a piece of seating furniture.

Against this background, the specific problem addressed by the present invention was that of providing additives which enable simple access to polyurethane systems, preferably polyurethane foams, especially free-rise flexible slabstock polyurethane foams or moulded foams having improved hardness with adequate open cell content. Adequate open cell content is especially understood to mean that the gas permeability of the polyurethane foam of the invention is preferably from 1 to 300 mm water column, preferably 3 to 250 mm water column, based on DIN EN ISO 4638:1993-07.

It has now been found that, surprisingly, this problem can be solved by the subject-matter of this invention, namely an additive suitable for increasing the hardness of polyurethane foams, especially flexible polyurethane foams, comprising at least one compound (V)

(i) containing more than three hydrogen atoms reactive toward isocyanates,

(ii) having an average hydroxyl number, determined to DIN 53240-1:2013-06, of 110-280 mg KOH/g, preferably of 120-250 mg KOH/g, and

(iii) containing >50 wt %, e.g. ≥51 wt %, preferably ≥53 wt %., further preferably ≥55 wt %., especially ≥60 wt %., of ethylene oxide bound within the molecule, wt % based on the total alkylene oxide content of the compound.

The term “additive” in the context of this invention encompasses an additive composition which may comprise at least one compound (V) as described above. This entire additive may comprise exactly one compound of this kind; the entire additive may consist of exactly one compound of this kind; the entire additive may comprise a plurality of different compounds (V) of this kind; the entire additive may consist of a plurality of different compounds (V) of this kind. In addition, the additive may also comprise further components, such as particularly one or more inorganic or organic solvents, preferably selected from water, alcohols, especially polyether monools or polyols, preferably consisting of H-functional starter substances, onto which alkylene oxides (epoxides) having 2-24 carbon atoms, preferably ethylene oxide and/or propylene oxide, have been added by alkoxylation, and which have a molecular weight of preferably 200-8000 g/mol, more preferably of 300-5000 g/mol, very preferably of 500-1000 g/mol, and a PO content of preferably 10-100 wt %, more preferably of 50-100 wt %, and also polyester monools or polyols having a molecular weight preferably in the range from 200 to 4500 g/mol, glycols, alkoxylates, carbonates, ethers, esters, branched or linear aliphatic or aromatic hydrocarbons and/or oils of synthetic and/or natural origin. An additive according to the invention that includes inorganic and/or organic solvent corresponds to a particularly preferred embodiment of the invention.

The subject-matter of the invention enables the surprisingly simple provision of polyurethane foam having improved, preferably particularly high, hardness and adequate open cell content. The improvement in hardness is based on the comparison with polyurethane foams which have been produced without additive of the invention but otherwise in an analogous manner. The provision of particularly high-quality foams having good, stable and homogeneous foam structure is enabled. The resulting foams exhibit, as a further advantage, favourable fire properties, i.e. fire- or flame-retardant properties, in the event of fire and have improved ageing properties. To study the ageing properties, a method based on ISO 3385-1975 has been developed and implemented. For this purpose, a foam specimen was compressed 80 000 times down to 70% of its original height and the loss of thickness and hardness was determined (detailed description in the Examples section). It is likewise advantageous that it is possible to resort to the usual production systems in the provision of the polyurethane foam. Still further advantages of the invention are that the additives of the invention are easy to handle, especially have low viscosity, and are advantageously hydrolysis-stable, low in emissions and virtually odour-neutral. They have a broad processing window and are producible in a reproducible manner by standard methods. The inventive use of the additive does not lead to any adverse effects in the physical properties of the foam. More particularly, tensile strength, compression set and expansion of the foam are not impaired.

This relates especially to the provision of flexible slabstock polyurethane foams, but very good results are also achieved in the context of the invention in the case of moulded PU foams.

The foam obtainable in accordance with the invention advantageously features the following properties that are adequate for the application: gas permeability (A), density (B), pore structure (C), compressive strength (D) and cell structure (E).

Flexible polyurethane foams that are preferred in the context of this invention and are obtainable by using the additive of the invention preferably have a gas permeability (A) of 1 to 300 mm water column and preferably 3 to 250 mm water column, based on DIN ISO 4638:1993-07, measured via measurement of the pressure differential in the course of flow through a foam sample. For this purpose, a foam sheet of thickness 5 cm is placed onto a smooth base. A plate of weight 800 g (10 cm×10 cm) having a central hole (diameter 2 cm) and a hose connection is placed onto the foam sample. Through the central hole, a constant air stream of 8 l/min is passed into the foam sample. The pressure differential that occurs (relative to unhindered outflow) is determined by means of a water column in a graduated pressure gauge. The more closed the foam is, the more pressure is built up and the more the level of the water column is forced downward and the greater the values that are measured.

The density (B) of flexible polyurethane foams that are preferred in accordance with the invention and are obtainable by use of the additive of the invention is preferably 5 to 150 kg/m³, more preferably 10 to 130 kg/m³ and especially preferably 15 to 100 kg/m³, measured to DIN EN ISO 845:2009-10.

The pore structure (C) (i.e. in the context of this invention the mean number of cells per 1 cm) of flexible polyurethane foams that are preferred in accordance with the invention and are obtainable by using the additive of the invention is preferably from 5 to 25 cells/cm and is determined visually on a section area, measured to DIN EN 15702.

Flexible polyurethane foams that are preferred in accordance with the invention and are obtainable by using the additive of the invention advantageously have, on 40% compression, a compressive strength (D) of 0.1 kPa to 15 kPa, preferably 0.5 to 13 kPa and especially of 2 to 11 kPa, determined in accordance with DIN EN ISO 3386-1:1997+A1:2010.

The cell structure (E) of the flexible polyurethane foams that are preferred in accordance with the invention and are obtainable by using the additive of the invention preferably has more than 80% open cells (measured to DIN ISO 4590).

Flexible polyurethane foams that are particularly preferred in the context of this invention and are obtainable by using the additive of the invention have a gas permeability (A) of 1 to 300 mm water column and preferably 3 to 250 mm water column, a density (B) of 5 to 150 kg/m³, preferably 10 to 130 kg/m³ and more preferably 15 to 100 kg/m³, a pore structure (C) having 5 to 25 cells/cm, a compressive strength (D) of 0.1 kPa to 15 kPa, preferably 0.5 to 13 kPa and especially 2 to 11 kPa, and a cell structure (E) having an open-cell content of more than 80%, with (A) to (E) each measured as specified above.

In a preferred embodiment of the invention, the compound (V) has a functionality of 4 to 10 and preferably 4 to 8. In the case of use of a plurality of compounds (V), functionalities that differ from whole numbers can occur, in which case they then relate to the mixture used, for example a functionality of 4.1-10, e.g. 4.5 or 5.5.

Functionality in the context of this invention means the presence of a functional group reactive toward isocyanates, for example a hydroxyl or amine group. A functionality of 3 thus describes a compound having three groups reactive toward isocyanates.

In a preferred embodiment of the invention, the compound (V) has predominantly, i.e. preferably at least 50% and more preferably at least 70%, primary OH groups.

The ratio of primary to secondary and tertiary OH end groups can be determined using NMR methods. For this purpose, the ¹³C NMR spectroscopy measurements can be conducted to determine the ratio of primary to secondary OH groups according to Standard Test Method D4273-05 from ASTM International. The assignment of the individual signals is familiar to the person skilled in the art and can be confirmed via the recording of a ¹³C APT NMR spectrum, or can optionally be effected by comparison with the signals of suitable example substances. Preferably, the determination is effected as hereinbelow described using an NMR spectrometer with processor unit and autosampler with 5 mm sample head from Bruker, 400 MHz type, 10 mm QNP, using 5 mm sample tubes and closure caps made of plastic for the proton NMR measurements and 10 mm sample tubes and closure caps made of plastic for the 13C measurements, both from Norell Inc. Sampling is effected using Pasteur pipettes from Brand. Reagents used are: deuterochloroform (CDCl₃) from Deutro, degree of deuteration 99.8%), A3 molecular sieve from Merck (to remove water residues from the solvent). The measurements are carried out using the measurement parameters reported in Table 1:

TABLE 1
Measurement parameters for NMR measurement

| | |
|---|---|
| ¹H NMR | ¹³C NMR |

| | | | | |
|---|---|---|---|---|
| Sample quantity | about 20 | mg | about 1 | g |
| CDCl₃ volume | about 1.25 | ml | about 5 | ml |
| Transmitter | 399.94 | MHz | 100.624 | MHz |
| frequency | | | | |
| Relaxation time | 0 | sec | 10 | sec |
| Transmitter offset | 1350.0 | Hz | 11 000 | Hz |

| | | |
|---|---|---|
| Number of scans | 16 | 512 |

| | | | | |
|---|---|---|---|---|
| Line width | 0.3 | Hz | 1 | Hz |

For this purpose, the stated sample quantity is introduced into a clean NMR tube and admixed with the stated volume of CDCl₃. The sample tube is sealed with the plastic cap and the sample is homogenized by shaking. After it has been degassed, for example utilizing an ultrasound bath for 1-5 seconds, the sample is analyzed in the NMR spectrometer.

In a particularly preferred embodiment of the invention, the ethylene oxide bound within the compound (V) is bonded in a terminal position, preferably in the form of blocks, at least to an extent of ≥50%, advantageously at least to an extent of 75%, preferably to an extent of ≥90%, especially to an extent of 100%, % based on the total amount of ethylene oxide bound within the molecule. In order to obtain a terminal ethylene oxide end block, as described in Example 1, after the alkylene oxide or alkylene oxide mixture used in a preceding metering block has been depleted by reaction and then the excess unconverted residual monomers have been removed under reduced pressure, exclusively ethylene oxide is added in a subsequent metering block.

“Bonded in a terminal position” in the context of this invention means that polymer chains which are formed by alkoxylation are concluded by a pure ethylene oxide end block and the polymer chains thus have primary OH groups.

In accordance with a further preferred embodiment of the invention, the additive of the invention, especially the compound (V), is a liquid at room temperature (T=20° C.) and atmospheric pressure.

The process of the invention, the additives of the invention and the use thereof are described in detail hereinafter with reference to advantageous embodiments. When ranges, general formulae or compound classes are specified hereinafter, these shall include not just the corresponding ranges or groups of compounds that are explicitly mentioned but also all sub-ranges and sub-groups of compounds which can be obtained by removing individual values (ranges) or compounds. Where documents are cited in the context of the present description, it is intended that their content fully form part of the disclosure content of the present invention. Unless stated otherwise, percentages are figures in percent by weight. When average values are reported hereinbelow, the values in question are weight averages, unless stated otherwise. Unless stated otherwise, the molar mass of the compounds used was determined in accordance with DIN 55672-1:2007-8 by gel permeation chromatography (GPC), with calibration against a polypropylene glycol standard (76-6000 g/mol). The structure of the compounds used was determined by NMR methods, especially by ¹³C and ¹H NMR. Hydroxyl numbers can be determined by titrimetric means to DIN 53240-1:2013-06. When chemical (empirical) formulae are used in the present invention, the reported indices can be not only absolute numbers but also average values. Indices relating to polymeric compounds are preferably average values. If measured values are reported hereinbelow, these measurements, unless stated otherwise, have been conducted under standard conditions (25° C. and 1013 mbar).

In accordance with a preferred embodiment of this invention, the inventive compound (V) is selected from compounds of the formula (I)

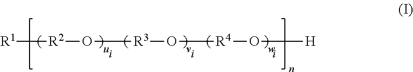

in which
R¹ is starter substance radical minus the hydrogen atoms active for the alkoxylation, for example molecular residues of polyhydric alcohols, polyfunctional amines, polyhydric thiols, carboxylic acids, amino alcohols, aminocarboxylic acids, thio alcohols, hydroxyl esters, polyether polyols, polyester polyols, polyester ether polyols, polycarbonate polyols, polyethyleneimines, polyether amines (e.g. Jeffamines® from Huntsman, for example T-403, T-3000, T-5000, or corresponding BASF products, for example Polyetheramin T403, T5000), polyether thiols, polyacrylate polyols, castor oil, of mono-, di- or triglycerides of ricinoleic acid, chemically modified mono-, di- and/or triglycerides of fatty acids and/or C1-C24 alkyl fatty acid esters containing an average of at least 3 OH groups per molecule,
R² is CH₂—CH(CH₃)
R³ is CH₂—CH₂
R⁴ is CH₂—CH(R⁵), CH(R⁶)—CH(R⁶), CH₂—C(R⁶)₂, C(R⁶)₂—C(R⁶)₂,

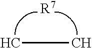

CH₂—CH—CH₂—R⁸, C₆H₆—CH—CH₂, C₆H₆—C(CH₃)—CH₂,
molecular residue of mono- or polyepoxidized fats or oils as mono-, di- and triglycerides or molecular residue of mono- or polyepoxidized fatty acids or the C₁-C₂₄-alkyl esters thereof
R⁵ is a C₂ to C₂₄ alkyl radical or alkene radical, which may be linear or branched
R⁶ is a C₂ to C₂₄ alkyl radical or alkene radical, which may be linear or branched
R⁷ is a C₃ to C₆ alkyl radical in linear arrangement
R⁸ is OH, Cl, OCH₃, OCH₂—CH₃, O—CH₂—CH═CH₂, O—CH═CH₂
and where
uᵢ≥0, preferably uᵢ≥1,
vᵢ≥1,
wᵢ is integers of 0-400; especially wᵢ=0,
n describes the functionality and may assume integer values from 4 to 25, preferably from 4 to 10, especially 4 to 8,
i has integer values from i=1 to n.

The sequence of the monomer units in the individual polymer chains 1 to n—apart from a preferred ethylene oxide end block—is arbitrary. In addition, the compositions of the n-polymer chains of the additive may be independent of one another. In addition, it may be the case that not all or just one of the n-polymer chains grows by means of alkoxylation during the addition.

If mixtures of starter substances are used, it is possible for different structures of additives of the general formula (I) to be present alongside one another.

If, in the formula (I), uᵢ, vᵢ, wᵢ≠0, or uᵢ, vᵢ≠0 and at the same time wᵢ=0, the individual (R²—O), (R³—O) and (R⁴—O) or (R²—O) and (R³—O) units—apart from a preferred ethylene oxide end block—may be bonded to one another in the form of blocks, in strict alternation, or in the form of gradients.

The chemical environment of individual alkylene oxide molecules, i.e. the presence of alkylene oxide blocks or a strict alternation of alkylene oxides used, can likewise be determined by means of NMR methods. The exact procedure is familiar to those skilled in the art.

Compounds of the formula (I) can be prepared by known processes, for example by anionic polymerization of alkylene oxides in the presence of alkali metal hydroxides or alkali metal alkoxides as catalysts, and with addition of at least one starter molecule containing preferably 4 or more reactive hydrogen atoms in bound form, or by cationic polymerization of alkylene oxides in the presence of Lewis acids, for example antimony pentachloride or boron fluoride etherate, or by double metal cyanide catalysis.

In general, for preparation of the additives of the invention, it is possible, for example, to use alkylene oxides (epoxides) having preferably 2-24 carbon atoms. The alkylene oxides having 2-24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C₁-C₂₄ esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkyloxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. More particularly, the alkylene oxides used are ethylene oxide and propylene oxide.

Suitable H-functional starter substances used may especially be compounds having hydrogen atoms active for the alkoxylation. Groups having active hydrogen atoms that are active for the alkoxylation are, for example, —OH, —NH₂ (primary amines), —NH— (secondary amines), —SH and —CO₂H, preference being given to —OH and —NH₂, particular preference to —OH. H-functional starter substances used are, for example, one or more compounds selected from the group consisting of polyhydric alcohols, polyfunctional amines, polyhydric thiols, carboxylic acids, amino alcohols, aminocarboxylic acids, thio alcohols, hydroxy esters, polyether polyols, polyester polyols, polyester ether polyols, polyether polycarbonate polyols, polyethyleneimines, polyetheramines (e.g. Jeffamines® from Huntsman, for example T-403, T-3000, T-5000 or corresponding BASF products, for example Polyetheramin T403, T5000), polyether thiols, polyacrylate polyols.

Polyhydric alcohols suitable as H-functional starter substances are, for example, tetrahydric alcohols (for example pentaerythritol or diglycerol); polyalcohols (for example sorbitol, other hexitols or pentitols, sucrose or other mono-, oligo- or polysaccharides, for example starch, starch hydrolysates, cellulose or cellulose hydrolysates, hydroxy-functionalized fats and oils, especially castor oil), and all modification products of these aforementioned alcohols with different amounts of ε-caprolactone.

The H-functional starter substances may also be selected from the substance class of the polyether polyols, especially those having a molecular weight Mn in the range from 100 to 4000 g/mol. Preference is given to polyether polyols formed from repeat ethylene oxide and propylene oxide units, preferably having a proportion of 35% to 100% propylene oxide units, more preferably having a proportion of 50% to 100% propylene oxide units. These may be random copolymers, gradient copolymers, alternating or block copolymers of ethylene oxide and propylene oxide. Suitable polyether polyols formed from repeat polypropylene oxide and/or ethylene oxide units are, for example, the Desmophen® and Arcol® polyether polyols from Bayer MaterialScience or the Voranol™ polyether polyols from Dow Chemical.

The H-functional starter substances may also be selected from the substance class of the polyester polyols, especially those having a molecular weight Mn in the range from 200 to 4500 g/mol. Polyester polyols used may be at least trifunctional polyesters. Preferably, polyester polyols consist of alternating acid and alcohol units. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride, citric acid or mixtures of said acids and/or anhydrides. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. If the alcohol component used comprises polyhydric polyether polyols, the result is polyester ether polyols which can likewise serve as starter substances for preparation of the additives (I). Preference is given to using polyether polyols having Mn=150 to 2000 g/mol for preparation of the polyester ether polyols.

The H-functional starter substances generally have a functionality (i.e. number of hydrogen atoms active for the polymerization per molecule) of 4 to 10, preferably of 4 to 8. The H-functional starter substances are used either individually or as a mixture of at least two H-functional starter substances.

Preferred H-functional starter substances are alcohols such as pentaerythritol, sorbitol, sucrose, reaction products of the alcohols with ε-caprolactone, e.g. reaction products of pentaerythritol with ε-caprolactone, reaction products of sorbitol with ε-caprolactone, and reaction products of sucrose with ε-caprolactone.

Compounds (V) preferred in accordance with the invention have a functionality of >3, preferably of 4 to 10 and most preferably of 4 to 8. In the case of use of a plurality of compounds (V), functionalities that differ from whole numbers can occur, in which case they then relate to the mixture used, for example a functionality of 4.1-10, e.g. 4.5 or 5.5.

Compounds (V) preferred in accordance with the invention have a number-average molecular weight of 600 to 6000, preferably 650 to 5000 and more preferably 670 to 4500. This corresponds to a preferred embodiment of the invention. The above-cited number-average molecular weights are number-average molecular weights determined on the basis of DIN 55672-1:2007-8 by gel permeation chromatography (GPC), calibration having been effected against a polypropylene glycol standard (76-6000 g/mol).

Preferably, the compounds (V) of the invention contain 51 to 100 wt %, preferably 55 to 99 wt % and more preferably 60 to 85 wt % of ethylene oxide and 0 to 49 wt %, preferably 1 to 45 wt % and more preferably 15 to 40 wt % of propylene oxide, wt % based on the total alkylene oxide content of the compound (V) as per formula (I).

The amount of additive composition is preferably chosen such that 0.1 to 10 parts by weight, especially 0.5 to 8 parts by weight, of compounds (V) are used per 100 parts of the total amount of polyol used. In the context of the present invention, a distinction is made between the compound (V) and other polyols. The compound (V) is also a polyol. In the aforementioned relationship of quantities, the expression “total amount of polyol used” refers to that polyol which is different from the compound (V).

Preferably, the PU system, especially PU foam, is made by expanding a mixture containing at least one urethane and/or isocyanurate catalyst, at least one blowing agent and/or water, at least one isocyanate component and a polyol mixture, in the presence of the additive of the invention.

As well as the components already mentioned, the mixture may include further customary constituents, for example optionally (further) blowing agents, optionally prepolymers, optionally flame retardants and optionally further additives (other than those mentioned in the additive composition according to the invention), for example fillers, emulsifiers which are preferably based on the reaction of hydroxyfunctional compounds with isocyanate, stabilizers, for example Si-containing and non-Si-containing, especially Si-containing and non-Si-containing organic stabilizers and surfactants, viscosity reducers, dyes, crosslinkers, antioxidants, UV stabilizers, biocides or antistats. It will be understood that a person skilled in the art seeking to produce the different types of flexible polyurethane foam, i.e. hot-cure, cold-cure or ester flexible polyurethane foams, will select the particular substances needed for this, e.g. isocyanate, polyol, prepolymer, stabilizers, etc., in an appropriate manner to obtain the particular type of flexible polyurethane foam desired.

A number of property rights describing suitable components and processes for producing the different types of flexible polyurethane foam, i.e. hot-cure, cold-cure and also ester flexible polyurethane foams, are indicated hereinbelow and are fully incorporated herein by reference: EP 0152878 A1, EP 0409035 A2, DE 102005050473 A1, DE 19629161 A1, DE 3508292 A1, DE 4444898 A1, EP 1061095 A1, EP 0532939 B1, EP 0867464 B1, EP 1683831 A1 and DE 102007046860 A1.

Further details of usable starting materials, catalysts and auxiliaries and additives can be found, for example, in Kunststoff-Handbuch [Plastics Handbook], volume 7, Polyurethane [Polyurethanes], Carl-Hanser-Verlag Munich, 1st edition 1966, 2nd edition 1983 and 3rd edition 1993.

The compounds, components and additives which follow are mentioned merely by way of example and can be replaced by other substances known to those skilled in the art.

Further surfactants employed in the production of flexible polyurethane foams are selectable, for example, from the group comprising nonionic surfactants and/or amphoteric surfactants.

Surfactants used may, in accordance with the invention, for example, also be polymeric emulsifiers such as polyalkyl polyoxyalkyl polyacrylates, polyvinylpyrrolidones or polyvinyl acetates. It is likewise possible to use, as surfactants/emulsifiers, prepolymers which are obtained by reaction of small amounts of isocyanates with polyols (called oligourethanes), and which are preferably present dissolved in polyols.

Foam stabilizers used may preferably be those which are known from the prior art and which are typically also employed for polyurethane foam stabilization. These may be both Si-containing and non-Si-containing, especially Si-containing and non-Si-containing organic stabilizers and surfactants. The Si-containing stabilizers are further distinguished by whether the polyoxyalkylene block is bonded to the polysiloxane block by a hydrolytically stable C—Si bond (as, for example, in EP 2 182 020) or by the less hydrolytically stable C—O—Si bond. The SiC-polysiloxane-polyoxyalkylene block copolymers usable for polyurethane foam stabilization can be prepared, for example, by noble metal-catalysed hydrosilylation of unsaturated polyoxyalkylenes with SiH-functional siloxanes, called hydrosiloxanes, as described, for example, in EP 1520870. The hydrosilylation can be conducted batchwise or continuously, as described, for example, in DE 19859759 C1.

A multitude of further documents, for example EP 0493836 A1, U.S. Pat. No. 5,565,194 or EP 1350804, each disclose polysiloxane-polyoxyalkylene block copolymers of a specific composition for fulfilment of specific profiles of demands for foam stabilizers in various polyurethane foam formulations.

Biocides used may be commercial products such as chlorophene, benzisothiazolinone, hexahydro-1,3,5-tris(hydroxyethyl-s-triazine), chloromethylisothiazolinone, methylisothiazolinone or 1,6-dihydroxy-2,5-dioxohexane, which are known by the trade names BIT 10, Nipacide BCP, Acticide MBS, Nipacide BK, Nipacide CI, Nipacide FC.

Suitable flame retardants for the purposes of this invention are any substances considered suitable therefore in the prior art. Examples of preferred flame retardants are liquid organophosphorus compounds such as halogen-free organophosphates, e.g. triethyl phosphate (TEP), halogenated phosphates, e.g. tris(1-chloro-2-propyl) phosphate (TCPP), tris(1,3-dichloro-2-propyl) phosphate (TDCPP) and tris(2-chloroethyl) phosphate (TCEP), and organic phosphonates, e.g. dimethyl methanephosphonate (DMMP), dimethyl propanephosphonate (DMPP), or solids such as ammonium polyphosphate (APP) and red phosphorus. Suitable flame retardants further include halogenated compounds, for example halogenated polyols, and also solids such as expandable graphite and melamine. All of these flame retardants and combinations thereof may be utilized advantageously in the sense of this invention, and include all commercially available flame retardants from the companies Great Lakes Solutions (Chemtura) (e.g.: DP-54™, Firemaster® BZ-54 HP, Firemaster® 550, Firemaster® 552, Firemaster® 600, Firemaster® 602, Reofos® 50, Reofos® 65, Reofos® 95, Kronitex® CDP), ICL Industrial Products (e.g.: FR-513, FR-1210, FR-1410, Fyrol™ FR-2, Fyrol™ 38, Fyrol™ HF-5, Fyrol™ A300TB, Fyrol™ PCF, Fyrol™ PNX, Fyrol™ PNX-LE), Clariant (e.g.: Exolit® OP 550 or Exolit® OP 560).

It is often the case that all the components except for the polyols and isocyanates are mixed to give an activator solution prior to the foaming. This solution then preferably comprises, inter alia, the additive usable in accordance with the invention, stabilizers, catalysts or catalyst combination, the blowing agent, for example water, and also any further additives, such as flame retardation, color, biocides, etc., depending on the recipe of the flexible polyurethane foam. An activator solution of this type may also be a composition according to the invention.

With regard to the blowing agents, a distinction is made between chemical and physical blowing agents. The chemical blowing agents include, for example, water, the reaction of which with the isocyanate groups leads to formation of CO₂. The apparent density of the foam can be controlled via the amount of water added, the preferred use amounts of water being between 0.5 and 10 parts, preferably between 1 and 7 parts, more preferably between 1 and 5 parts, based on 100.0 parts of polyol. In addition, it is alternatively and/or else additionally possible to use physical blowing agents. These are liquids which are inert to the formulation constituents and have boiling points below 100° C., preferably below 50° C., especially between −50° C. and 30° C., at atmospheric pressure, such that they evaporate under the influence of the exothermic polyaddition reaction. Examples of such liquids usable with preference are ketones such as acetone and/or methyl ethyl ketone, hydrocarbons such as n-, iso- or cyclopentane, n- or isobutane and propane, cyclohexane, ethers such as dimethyl ether and diethyl ether, halogenated hydrocarbons such as methylene chloride, tetrafluoroethane, pentafluoropropane, heptafluoropropane, pentafluorobutane, hexafluorobutane and/or dichloromonofluoroethane, trichlorofluoromethane, dichlorotetrafluoroethane and 1,1,2-trichloro-1,2,2-trifluoroethane. In addition, it is also possible to use carbon dioxide. It is also possible to use mixtures of these low-boiling liquids with one another and/or with other substituted or unsubstituted hydrocarbons. The foaming may proceed either under standard pressure or under reduced pressure (VPF technology).

The amount of physical blowing agent here is preferably in the range between 1 to 30 parts by weight, in particular 1 to 15 parts by weight, while the amount of water is preferably in the range between 0.5 to 10 parts by weight, in particular 1 to 5 parts by weight. Carbon dioxide is preferred among the physical blowing agents, and is preferably used in combination with water as chemical blowing agent.

The activator solution may additionally comprise all the customary additives known for activator solutions in the prior art. The additives may be selected from the group comprising flame retardants, antioxidants, UV stabilizers, dyes, biocides, pigments, cell openers, crosslinkers and the like.

A flexible polyurethane foam is preferably produced by reacting a mixture (mix) of polyol, di- or polyfunctional isocyanate, additive of the invention, amine catalyst, potassium compound, organozinc compound and/or organotin compound or other metal-containing catalysts, stabilizer, blowing agent, preferably water to form CO₂ and, if necessary, addition of physical blowing agents, optionally under admixture of flame retardants, antioxidants, UV stabilizers, color pastes, biocides, fillers, crosslinkers or other customary processing auxiliaries. Such a mixture likewise forms part of the subject-matter of the invention. A mixture comprising the additive for use in accordance with the invention and polyol likewise forms part of the subject-matter of the invention.

Isocyanates used may be organic isocyanate compounds containing at least two isocyanate groups. In general, useful isocyanates are the aliphatic, cycloaliphatic, araliphatic and preferably aromatic polyfunctional isocyanates known per se. Isocyanates are more preferably used at from 60 to 140 mol %, relative to the sum total of isocyanate-consuming components.

Specific examples include the following: alkylene diisocyanates having 4 to 12 carbon atoms in the alkylene radical, such as dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate, cycloaliphatic diisocyanates such as cyclohexane 1,3- and 1,4-diisocyanate and any desired mixtures of these isomers, 1-isocyanato-3,3,5-trimethyl-5-isocyanatomethylcyclohexane (IPDI), hexahydrotolylene 2,4- and 2,6-diisocyanate and the corresponding isomer mixtures, dicyclohexylmethane 4,4′-, 2,2′- and 2,4′-diisocyanate and the corresponding isomer mixtures, and preferably aromatic di- and polyisocyanates, for example tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,2′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates. Organic di- and polyisocyanates can be used individually or as mixtures thereof.

It is also possible to use isocyanates which have been modified by the incorporation of urethane, uretdione, isocyanurate, allophanate and other groups, called modified isocyanates.

Organic polyisocyanates have been found to be particularly useful and are therefore employed with preference:

tolylene diisocyanate, mixtures of diphenylmethane diisocyanate isomers, mixtures of diphenylmethane diisocyanate and polyphenylpolymethyl polyisocyanate or tolylene diisocyanate with diphenylmethane diisocyanate and/or polyphenylpolymethyl polyisocyanate or what are called prepolymers.

It is possible to use either TDI (tolylene 2,4- and 2,6-diisocyanate isomer mixture) or MDI (diphenylmethane 4,4′-diisocyanate). What is called “crude MDI” or “polymeric MDI” contains, as well as the 4,4′ isomers, also the 2,4′ and 2,2′ isomers, and also higher polycyclic products. “Pure MDI” refers to bicyclic products composed predominantly of 2,4′ and 4,4′ isomer mixtures or prepolymers thereof. Further suitable isocyanates are detailed in patent specification EP 1095968, to which reference is made here in full.

In a particularly preferred embodiment, the isocyanate component used is TDI-80.

Crosslinkers refer to low molecular weight polyfunctional compounds that are reactive toward isocyanates. Suitable examples are polyfunctional, especially di- and trifunctional compounds having molecular weights of 62 to 1000 g/mol, preferably 62 to 600 g/mol. Those used include, for example, di- and trialkanolamines such as diethanolamine and triethanolamine, aliphatic and aromatic diamines, for example ethylenediamine, butylenediamine, butylene-1,4-diamine, hexamethylene-1,6-diamine, 4,4′-diaminodiphenylmethane, 3,3′-dialkyl-substituted 4,4′-diaminodiphenylmethanes, tolylene-2,4- and -2,6-diamine, and preferably aliphatic diols and triols having 2 to 6 carbon atoms, such as ethylene glycol, propylene glycol, 1,4-butylene glycol, 1,6-hexamethylene glycol, 2-methylpropane-1,3-diol, glycerol and trimethylolpropane or castor oil or pentaerythritol, and also higher polyhydric alcohols such as sugar alcohols, for example sucrose, glucose or sorbitol, and alkoxylated compounds of all the aforementioned examples.

The additives of the invention can especially be used in slabstock foaming. It is possible to use all processes known to those skilled in the art for production of free-rise flexible polyurethane foams. For example, the foaming operation can be effected either in the horizontal or in the vertical direction, in batchwise or continuous systems. The additive compositions usable in accordance with the invention can be similarly used for CO₂ technology. Use in low-pressure and high-pressure machines is possible, in which case the formulations of the invention can be metered directly into the mixing chamber or else are added upstream of the mixing chamber to one of the components which subsequently pass into the mixing chamber. The addition can also be effected in the raw material tank.

Polyols suitable as polyol component for the purposes of the present invention are all organic substances having two or more isocyanate-reactive groups, preferably OH groups, and also formulations thereof. All polyether polyols and polyester polyols typically used for production of polyurethane systems, especially polyurethane foams, are preferred polyols.

These may, for example, be polyether polyols or polyester polyols which typically bear 2 to 8 OH groups per molecule and, as well as carbon, hydrogen and oxygen, may also contain heteroatoms such as nitrogen, phosphorus or halogens; preference is given to using polyether polyols. Polyols of this kind can be prepared by known processes, for example by anionic polymerization of alkylene oxides in the presence of alkali metal hydroxides or alkali metal alkoxides as catalysts, and with addition of at least one starter molecule containing preferably 2 or 3 reactive hydrogen atoms in bound form, or by cationic polymerization of alkylene oxides in the presence of Lewis acids, for example antimony pentachloride or boron fluoride etherate, or by double metal cyanide catalysis. Suitable alkylene oxides contain from 2 to 4 carbon atoms in the alkylene moiety. Examples are tetrahydrofuran, 1,2-propylene oxide, 1,2- or 2,3-butylene oxide; preference is given to using ethylene oxide and/or 1,2-propylene oxide. The alkylene oxides may be used individually, in alternation or as mixtures. H-functional starter substances used are especially polyfunctional alcohols and/or amines. Alcohols used with preference are dihydric alcohols, for example ethylene glycol, propylene glycol, or butanediols, trihydric alcohols, for example glycerol, trimethylolpropane or castor oil or pentaerythritol, and higher polyhydric alcohols, such as sugar alcohols, for example sucrose, glucose or sorbitol. Amines used with preference are aliphatic amines having up to 10 carbon atoms, for example ethylenediamine, diethylenetriamine, propylenediamine, aromatic amines, for example tolylenediamine or diaminodiphenylmethane, and also amino alcohols such as ethanolamine or diethanolamine.

Polyester polyols can be prepared by polycondensation reaction or by ring-opening polymerization. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of said acids and/or anhydrides. Alcohol components used are, for example, ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane, diethylene glycol, dipropylene glycol, trimethylolpropane, glycerol, pentaerythritol or mixtures of the stated alcohols. If the alcohol component used is dihydric or polyhydric polyether polyols, the result is polyester ether polyols which can likewise serve as starter substances for preparation of the polyether polycarbonate polyols. Preference is given to using polyether polyols having Mn=150 to 2000 g/mol for preparation of the polyester ether polyols.

The polyether polyols, preferably polyoxypropylenepolyoxyethylene polyols, typically have a functionality of 2 to 8 and number-averaged molecular weights preferably in the range from 500 to 8000, preferably 800 to 4500. Further polyols are known to those skilled in the art and can be found, for example, in EP-A-0 380 993 or U.S. Pat. No. 3,346,557, which are fully incorporated herein by reference.

High-elasticity flexible polyurethane foams (cold-cure foam) are preferably produced by employing di- and/or trifunctional polyether alcohols preferably having above 50 mol % of primary hydroxyl groups, based on the sum total of hydroxyl groups, in particular those having an ethylene oxide block at the chain end or those based exclusively on ethylene oxide.

Slabstock flexible foams are preferably produced by employing di- and/or trifunctional polyether alcohols having secondary hydroxyl groups, preferably above 80 mol %, in particular those having a propylene oxide block or random propylene oxide and ethylene oxide block at the chain end, or those based exclusively on propylene oxide blocks.

A further class of polyols is of those which are obtained as prepolymers by reaction of polyol with isocyanate in a molar ratio of 100:1 to 5:1, preferably 50:1 to 10:1. Such prepolymers are preferably used in the form of a solution in polyol, and the polyol preferably corresponds to the polyol used for preparing the prepolymers.

Yet a further class of polyols is that of the so-called filled polyols (polymer polyols). These contain dispersed solid organic fillers up to a solids content of 40 wt % or more. Those used include the following:

SAN polyols: These are highly reactive polyols containing a dispersed copolymer based on styrene-acrylonitrile (SAN).

PHD polyols: These are highly reactive polyols containing polyurea, likewise in dispersed form.

PIPA polyols: These are highly reactive polyols containing a dispersed polyurethane, for example formed by in situ reaction of an isocyanate with an alkanolamine in a conventional polyol.

The solids content, which is preferably between 5% and 40 wt %, based on the polyol, depending on the application, is responsible for improved cell opening, and so the polyol can be foamed in a controlled fashion, especially with TDI, and no shrinkage of the foams occurs. The solids content thus acts as an essential processing aid. A further function is to control the hardness via the solids content, since higher solids contents bring about a higher hardness on the part of the foam.

The formulations with solids-containing polyols have distinctly lower intrinsic stability and therefore tend also to additionally require physical stabilization in addition to the chemical stabilization due to the crosslinking reaction.

Depending on the solids content of the polyols, these are used alone or in a blend with the abovementioned unfilled polyols.

A further class of useful polyols is that of the so-called autocatalytic polyols, in particular autocatalytic polyether polyols. Polyols of this kind are based, for example, on polyether blocks, preferably on ethylene oxide and/or propylene oxide blocks, and additionally include catalytically active functional groups, for example nitrogen-containing functional groups, especially amino groups, preferably tertiary amine functions, urea groups and/or heterocycles containing nitrogen atoms. Through the use of such autocatalytic polyols in the production of polyurethane systems, especially of polyurethane foams, preferably of flexible polyurethane foams, it is possible, as the case may be, to reduce the required amount of any catalysts used in addition, depending on the application, and/or to match it to specific desired foam properties. Suitable polyols are described, for example, in WO0158976 (A1), WO2005063841 (A1), WO0222702 (A1), WO2006055396 (A1), WO03029320 (A1), WO0158976 (A1), U.S. Pat. No. 6,924,321 (B2), U.S. Pat. No. 6,762,274 (B2), EP2104696 (B1), WO2004060956 (A1) or WO2013102053 (A1) and can be purchased, for example, under the Voractiv™ and/or SpecFlex™ Activ trade names from Dow.

Blowing agents used may be the known blowing agents. Preferably, in the production of the polyurethane foam, water, methylene chloride, pentane, alkanes, halogenated alkanes, acetone and/or carbon dioxide are used as blowing agents.

The water can be added directly to the mixture or else be added to the mixture as a secondary component of one of the reactants, for example of the polyol component, together with the latter.

In addition to physical blowing agents and any water, it is also possible to use other chemical blowing agents which react with isocyanates to evolve a gas, an example being formic acid.

Catalysts used in the context of this invention may, for example, be any catalysts for the isocyanate-polyol (urethane formation) and/or isocyanate-water (amine and carbon dioxide formation) and/or isocyanate dimerization (uretdione formation), isocyanate trimerization (isocyanurate formation), isocyanate-isocyanate with CO₂ elimination (carbodiimide formation) and/or isocyanate-amine (urea formation) reactions and/or “secondary” crosslinking reactions such as isocyanate-urethane (allophanate formation) and/or isocyanate-urea (biuret formation) and/or isocyanate-carbodiimide (uretimide formation).

Suitable catalysts for the purposes of the present invention are, for example, substances which catalyse one of the aforementioned reactions, especially the gelling reaction (isocyanate-polyol), the blowing reaction (isocyanate-water) and/or the dimerization or trimerization of the isocyanate. Such catalysts are preferably nitrogen compounds, especially amines and ammonium salts, and/or metal compounds.

Suitable nitrogen compounds as catalysts, also referred to hereinafter as nitrogenous catalysts, for the purposes of the present invention are all nitrogen compounds according to the prior art which catalyse one of the abovementioned isocyanate reactions and/or can be used for production of polyurethanes, especially of polyurethane foams.

Examples of suitable nitrogen compounds as catalysts for the purposes of the present invention are preferably amines, especially tertiary amines or compounds containing one or more tertiary amine groups, including the amines triethylamine, N,N-dimethylcyclohexylamine, N,N-dicyclohexylmethylamine, N,N-dimethylaminoethylamine, N,N,N′,N′-tetramethylethylene-1,2-diamine, N,N,N′,N′-tetramethylpropylene-1,3-diamine, N,N,N′,N′-tetramethyl-1,4-butanediamine, N,N,N′,N′-tetramethyl-1,6-hexanediamine, N,N,N′,N″,N″-pentamethyldiethylenetriamine, N,N,N′-trimethylaminoethylethanolamine, N,N-dimethylaminopropylamine, N,N-diethylaminopropylamine, N,N-dimethylaminopropyl-N′,N′-dipropan-2-olamine, 2-[[3-(dimethylamino)propyl]methylamino]ethanol, 3-(2-dimethylamino)ethoxy)propylamine, N,N-bis[3-(dimethylamino)propyl]amine, N,N,N′,N″,N″-pentamethyldipropylenetriamine, 1-[bis[3-(dimethylamino)propyl]amino]-2-propanol, N,N-bis[3-(dimethylamino)propyl]-N′,N′-dimethylpropane-1,3-diamine, triethylenediamine, 1,4-diazabicyclo[2.2.2]octane-2-methanol, N,N′-dimethylpiperazine, 1,2-dimethylimidazole, N-(2-hydroxypropyl)imidazole, 1-isobutyl-2-methylimidazole, N-(3-aminopropyl)imidazole, N-methylimidazole, N-ethylmorpholine, N-methylmorpholine, 2,2,4-trimethyl-2-silamorpholine, N-ethyl-2,2-dimethyl-2-silamorpholine, N-(2-aminoethyl)morpholine, N-(2-hydroxyethyl)morpholine, 2,2′-dimorpholinodiethyl ether, N,N′-dimethylpiperazine, N-(2-hydroxyethyl)piperazine, N-(2-aminoethyl)piperazine, N,N-dimethylbenzylamine, N,N-dimethylaminoethanol, N,N-diethylaminoethanol, 3-dimethylamino-1-propanol, N,N-dimethylaminoethoxyethanol, N,N-diethylaminoethoxyethanol, bis(2-dimethylaminoethyl ether), N,N,N′-trimethyl-N′-(2-hydroxyethyl)bis(2-aminoethyl) ether, N,N,N′-trimethyl-N-3′-aminopropyl(bisaminoethyl) ether, tris(dimethylaminopropyl)hexahydro-1,3,5-triazine, 1,8-diazabicyclo[5.4.0]undec-7-ene, 1,5-diazabicyclo[4.3.0]non-5-ene, 1,5,7-triazabicyclo[4.4.0]dec-5-ene, N-methyl-1,5,7-triazabicyclo[4.4.0]dec-5-ene, 1,4,6-triazabicyclo[3.3.0]oct-4-ene, 1,1,3,3-tetramethylguanidine, tert-butyl-1,1,3,3-tetramethylguanidine, guanidine, 3-dimethylaminopropylurea, 1,3-bis[3-(dimethylamino)propyl]urea, bis-N,N-(dimethylaminoethoxyethyl)isophoronedicarbamate, 3-dimethylamino-N,N-dimethylpropionamide and 2,4,6-tris(dimethylaminomethyl)phenol. Suitable nitrogenous catalysts according to the prior art can be purchased, for example, from Evonik under the TEGOAMIN® trade name.

According to the application, it may be preferable that, in the inventive production of polyurethane foams, quaternized and/or protonated nitrogenous catalysts, especially quaternized and/or protonated tertiary amines, are used.

For possible quaternization of nitrogenous catalysts, it is possible to use any reagents known as quaternizing reagents. Preferably, quaternizing agents used are alkylating agents, for example dimethyl sulphate, methyl chloride or benzyl chloride, preferably methylating agents such as dimethyl sulphate in particular. Quaternization is likewise possible with alkylene oxides, for example ethylene oxide, propylene oxide or butylene oxide, preferably with subsequent neutralization with inorganic or organic acids.

Nitrogenous catalysts, if quaternized, may be singly or multiply quaternized. Preferably, the nitrogenous catalysts are only singly quaternized. In the case of single quaternization, the nitrogenous catalysts are preferably quaternized on a tertiary nitrogen atom.

Nitrogenous catalysts can be converted to the corresponding protonated compounds by reaction with organic or inorganic acids. These protonated compounds may be preferable, for example, when, for example, a slowed polyurethane reaction is to be achieved or when the reaction mixture is to have enhanced flow in use.

Useful organic acids include, for example, any hereinbelow recited organic acids, for example carboxylic acids having 1 to 36 carbon atoms (aromatic or aliphatic, linear or branched), for example formic acid, lactic acid, 2-ethylhexanoic acid, salicylic acid and neodecanoic acid, or else polymeric acids such as, for example, polyacrylic or polymethacrylic acids. Inorganic acids used may, for example, be phosphorus-based acids, sulphur-based acids or boron-based acids.

However, the use of nitrogenous catalysts which have not been quaternized or protonated is particularly preferred in the context of this invention.

Suitable metal compounds as catalysts, also referred to hereinafter as metallic catalysts, for the purposes of the present invention are all metal compounds according to the prior art which catalyse one of the abovementioned isocyanate reactions and/or can be used for production of polyurethanes, especially of polyurethane foams. They may be selected, for example, from the group of the metal-organic or organometallic compounds, metal-organic or organometallic salts, organic metal salts, inorganic metal salts, and from the group of the charged or uncharged metal-containing coordination compounds, especially the metal chelate complexes.

The expression “metal-organic or organometallic compounds” in the context of this invention especially encompasses the use of metal compounds having a direct carbon-metal bond, also referred to here as metal organyls (e.g. tin organyls) or organometallic compounds (e.g. organotin compounds). The expression “organometallic or metal-organic salts” in the context of this invention especially encompasses the use of metal-organic or organometallic compounds having salt character, i.e. ionic compounds in which either the anion or cation is organometallic in nature (e.g. organotin oxides, organotin chlorides or organotin carboxylates). The expression “organic metal salts” in the context of this invention especially encompasses the use of metal compounds which do not have any direct carbon-metal bond and are simultaneously metal salts, in which either the anion or the cation is an organic compound (e.g. tin(II) carboxylates). The expression “inorganic metal salts” in the context of this invention especially encompasses the use of metal compounds or of metal salts in which neither the anion nor the cation is an organic compound, e.g. metal chlorides (e.g. tin(II) chloride), pure metal oxides (e.g. tin oxides) or mixed metal oxides, i.e. containing a plurality of metals, and/or metal silicates or aluminosilicates. The expression “coordination compound” in the context of this invention especially encompasses the use of metal compounds formed from one or more central particles and one or more ligands, the central particles being charged or uncharged metals (e.g. metal- or tin-amine complexes). The expression “metal-chelate complexes” is to be understood for the purposes of this invention as comprehending in particular the use of metal-containing coordination compounds wherein the ligands have at least two sites for coordinating or binding with the metal centre (e.g. metal- or to be more precise tin-polyamine or metal- or to be more precise tin-polyether complexes).

Suitable metal compounds, especially as defined above, as catalysts in the sense of the present invention may be selected, for example, from all metal compounds comprising lithium, sodium, potassium, magnesium, calcium, scandium, yttrium, titanium, zirconium, vanadium, niobium, chromium, molybdenum, tungsten, manganese, cobalt, nickel, copper, zinc, mercury, aluminium, gallium, indium, germanium, tin, lead, and/or bismuth, especially sodium, potassium, magnesium, calcium, titanium, zirconium, molybdenum, tungsten, zinc, aluminium, tin and/or bismuth, more preferably tin, bismuth, zinc and/or potassium.

Suitable organometallic salts and organic metal salts, as defined above, as catalysts for the purposes of the present invention are, for example, organotin, tin, zinc, bismuth and potassium salts, in particular corresponding metal carboxylates, alkoxides, thiolates and mercaptoacetates, for example dibutyltin diacetate, dimethyltin dilaurate, dibutyltin dilaurate (DBTDL), dioctyltin dilaurate (DOTDL), dimethyltin dineodecanoate, dibutyltin dineodecanoate, dioctyltin dineodecanoate, dibutyltin dioleate, dibutyltin bis(n-lauryl mercaptide), dimethyltin bis(n-lauryl mercaptide), monomethyltin tris(2-ethylhexyl mercaptoacetate), dimethyltin bis(2-ethylhexyl mercaptoacetate), dibutyltin bis(2-ethylhexyl mercaptoacetate), dioctyltin bis(isooctyl mercaptoacetate), tin(II) acetate, tin(II) 2-ethylhexanoate (tin(II) octoate), tin(II) isononanoate (tin(II) 3,5,5-trimethylhexanoate), tin(II) neodecanoate, tin(II) ricinoleate, tin(II) oleate, zinc(II) acetate, zinc(II) 2-ethylhexanoate (zinc(II) octoate), zinc(II) isononanoate (zinc(II) 3,5,5-trimethylhexanoate), zinc(II) neodecanoate, zinc(II) ricinoleate, bismuth acetate, bismuth 2-ethylhexanoate, bismuth octoate, bismuth isononanoate, bismuth neodecanoate, potassium formate, potassium acetate, potassium 2-ethylhexanoate (potassium octoate), potassium isononanoate, potassium neodecanoate and/or potassium ricinoleate.

In the inventive production of polyurethane foams, it may be preferable to rule out the use of organometallic salts, for example of dibutyltin dilaurate.

Suitable metallic catalysts are generally selected with preference such that they do not have any inherent nuisance odour, are substantially unobjectionable toxicologically, and endow the resultant polyurethane systems, especially polyurethane foams, with as low a level of catalyst-induced emissions as possible.

In the inventive production of polyurethane foams, it may be preferable, according to the type of application, to use incorporable/reactive or high molecular weight catalysts. Catalysts of this kind may be selected, for example, from the group of the metal compounds, preferably from the group of the tin, zinc, bismuth and/or potassium compounds, especially from the group of the metal carboxylates of the aforementioned metals, for example the tin, zinc, bismuth and/or potassium salts of isononanoic acid, neodecanoic acid, ricinoleic acid and/or oleic acid, and/or from the group of the nitrogen compounds, especially from the group of the low-emission amines and/or the low-emission compounds containing tertiary one or more tertiary amine groups, for example described by the amines dimethylaminoethanol, N,N-dimethyl-N′,N′-di(2-hydroxypropyl)-1,3-diaminopropane, N,N-dimethylaminopropylamine, N,N,N′-trimethyl-N′-hydroxyethylbis(aminoethyl) ether, 6-dimethylaminoethyl-1-hexanol, N-(2-hydroxypropyl)imidazole, N-(3-aminopropyl)imidazole, aminopropyl-2-methylimidazole, N,N,N′-trimethylaminoethanolamine, 2-(2-(N,N-dimethylaminoethoxy)ethanol, N-(dimethyl-3-aminopropyl)urea derivatives and alkylaminooxamides, such as bis(N-(N′,N′-dimethylaminopropyl))oxamide, bis(N-(N′,N′-dimethylaminoethyl))oxamide, bis(N-(N′,N′-imidazolidinylpropyl)oxamide, bis(N-(N′,N′-diethylaminoethyl))oxamide, bis(N-(N′,N′-diethylaminopropyl)oxamide, bis(N-(N′,N′-diethylaminoethyl)oxamide, bis(N-(N′,N′-diethylimino-1-methylpropyl)oxamide, bis(N-(3-morpholinopropylyl)oxamide, and the reaction products thereof with alkylene oxides, preferably having a molar mass in the range between 160 and 500 g/mol, and compounds of the general formula:

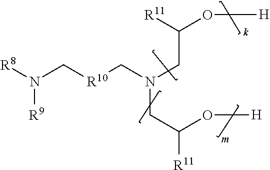

with

R⁸, R⁹═—CₐH₂ₐ₊ᵢ with a=1-4 for acyclic groups

R⁸, R⁹═—C_{b}H_{c}N_{d}— with b=3-7, c=6-14, d=0-2 for cyclic groups

R¹⁰═CₑH_{f}O₉ with e=0-4, f=0-8, g=0-2

R¹¹═—H, —CH₃, —C₂H₅

k, m=identically or differently 1-5.

Catalysts and/or mixtures of this kind are supplied commercially, for example, under the Jeffcat® ZF-10, Lupragen® DMEA, Lupragen® API, Toyocat® RX 20 and Toyocat® RX 21, DABCO® RP 202, DABCO® RP 204, DABCO® NE 300, DABCO® NE 310, DABCO® NE 400, DABCO® NE 500, DABCO® NE 600, DABCO® NE 1060 and DABCO® NE 2039, Niax® EF 860, Niax® EF 890, Niax® EF 700, Niax® EF 705, Niax® EF 708, Niax® EF 600, Niax® EF 602, Kosmos® 54, Kosmos® EF, and Tegoamin® ZE 1 names.

Suitable use amounts of catalysts are guided by the type of catalyst and are preferably in the range from 0.005 to 10.0 pphp, more preferably in the range from 0.01 to 5.00 pphp (=parts by weight based on 100 parts by weight of polyol) or 0.10 to 10.0 pphp for potassium salts.

According to the application, it may be preferable that, in the inventive production of polyurethane foams, one or more nitrogenous and/or metallic catalysts are used. When more than one catalyst is used, the catalysts may be used in any desired mixtures with one another. It is possible here to use the catalysts individually during the foaming operation, for example in the manner of a preliminary dosage in the mixing head, and/or in the form of a premixed catalyst combination.

The expression “premixed catalyst combination”, also referred to hereinafter as catalyst combination, for the purposes of this invention especially encompasses ready-made mixtures of metallic catalysts and/or nitrogenous catalysts and/or corresponding protonated and/or quaternized nitrogenous catalysts, and optionally also further ingredients or additives, for example water, organic solvents, acids for blocking the amines, emulsifiers, surfactants, blowing agents, antioxidants, flame retardants, stabilizers and/or siloxanes, preferably polyether siloxanes, which are already present as such prior to the foaming and need not be added as individual components during the foaming operation.

According to the application, it may be preferable when the sum total of all the nitrogenous catalysts used relative to the sum total of the metallic catalysts, especially potassium, zinc and/or tin catalysts, results in a molar ratio of 1:0.05 to 0.05:1, preferably 1:0.07 to 0.07:1 and more preferably 1:0.1 to 0.1:1.

In order to prevent any reaction of the components with one another, especially reaction of nitrogenous catalysts with metallic catalysts, especially potassium, zinc and/or tin catalysts, it may be preferable to store these components separately from one another and then to feed them into the isocyanate and polyol reaction mixture simultaneously or successively.

The present invention likewise provides a process for producing polyurethane foams by reacting
(a) one or more polyol components with
(b) one or more isocyanate components,

in the presence of
(c) the additive of the invention, as described above,
(d) catalysts,
(e) water and optionally organic blowing agents,
(g) stabilizers and optionally emulsifiers and
(f) optionally other additives.

The process enables the provision of polyurethane foams having increased hardness and adequate open cell content, and also improved ageing resistance.

In the context of the present invention, a distinction is made between the compound (V) and other polyol components. The compound (V) is also a polyol component. In the aforementioned process, the term “polyol components” encompasses such polyol which is different from the compound (V).

With the inventive polyurethane system, especially polyurethane foam, it is possible to obtain articles including or consisting of this polyurethane system, especially polyurethane foam. These articles represent a further subject of this invention. Such articles are especially furniture cushioning or mattresses.

This invention additionally further provides a polyurethane foam comprising the reaction products of one or more polyol components with one or more isocyanate components, with at least one compound (V) of the formula (I) as described specifically above functioning as crosslinker, especially a polyurethane foam obtainable by the process of the invention as described above.

The invention further provides for the use of the inventive polyurethane foam as packaging foam, mattress, furniture cushioning, material in motor vehicle interiors, automobile seat cushioning, headrest, automobile interior trim, sound absorption material, shoe sole, carpet backing foam, filter foam, or for production of corresponding products, especially as material in motor vehicle interiors. Particular preference is given to use as a mattress, furniture cushioning, material in motor vehicle interiors, automobile seat cushioning, headrest, sound absorption material, or for production of corresponding products, especially as material in motor vehicle interiors.

A preferred composition according to the invention for producing a polyurethane system, especially polyurethane foam, may contain polyol in amounts of 25 to 80 wt %, water in amounts of 1 to 5 wt %, catalyst in amounts of 0.05 to 1 wt %, physical blowing agent in amounts of 0 to 25 wt % (e.g. 0.1 to 25 wt %), stabilizers (for example, silicon-containing and non-silicon-containing, in particular silicon-containing and non-silicon-containing organic stabilizers and surfactants) in amounts of 0.1 to 5 wt %, isocyanate in amounts of 20 to 50 wt %, and compounds (V) of the invention in amounts of 0.001 to 10 wt %, preferably 0.1 to 5 wt %.

For preferred embodiments of these abovementioned compositions, reference is made explicitly to the preceding description.

The invention further provides for the use of an additive of the invention for improving the hardness of flexible polyurethane foam and/or for improving the ageing properties of flexible polyurethane foam in the course of foam production. In this context, it is possible to improve the hardness of flexible polyurethane foam with an adequate open cell content. Adequate open cell content is especially understood to mean that the gas permeability of the polyurethane foam of the invention is preferably from 1 to 300 mm water column, preferably 3 to 250 mm water column, based on DIN EN ISO 4638:1993-07. The use of the additive of the invention enables an improvement in the hardness in that the hardness of the foam is higher than that of such foam which has been provided without the additive of the invention but in an otherwise analogous manner. The improvement in the ageing properties of flexible polyurethane foam is especially based on mechanical stress on the foam, and the ageing properties can be examined by conducting a method based on ISO 3385-1975 in which a foam specimen is compressed 80 000 times down to 70% of its original height and the loss of thickness and hardness is ascertained. The use of the additive of the invention enables an improvement in the ageing properties in that the loss of thickness and hardness of the foam is smaller than that of such foam which has been provided without the additive of the invention in an otherwise analogous manner.

The subject-matter of the present invention is elucidated in detail hereinafter with reference to examples, without any intention that the subject-matter of the invention be restricted to these illustrative embodiments.

### EXAMPLES

Preparation of the Inventive Additives

### Example 1 (Inventive)

A 10 l stirred autoclave was initially charged with 500 g of pentaerythritol and 110 g of aqueous potassium hydroxide solution (47%), and the alkoxide was formed at 90° C. and reduced pressure (25 mbar) over the course of 1 hour. The pressure was equalized with nitrogen and the reaction temperature was increased to 120° C. and 1705 g of propylene oxide were metered in at a constant rate over the course of 4 hours. After a continued reaction time of 2 hours, the residual monomers were removed under reduced pressure (1 mbar, 30 minutes, 110° C.). After nitrogen had been injected to 2.8 bar for inertization, 5173 g of ethylene oxide were metered in in a second metering block at 120° C. over the course of 4 hours. After a second continued reaction time of 2 hours and another removal of the residual monomers under reduced pressure (1 mbar, 30 minutes, 110° C.), the crude product was hydrolysed, neutralized with phosphoric add and then vacuum-distilled and filtered. The product thus obtained had a hydroxyl number of 209.4 mg KOH/g, a content of primary hydroxyl groups of 92% of the total number of hydroxyl groups and a residual water content of 0.02 wt %, based on the total weight of the product. The ethylene oxide content in the molecule was 75 wt % based on the total alkylene oxide content.

### Example 2 (Inventive)

A 10 l stirred autoclave was initially charged with 500 g of sorbitol and 30 g of aqueous potassium hydroxide solution (47%), and the alkoxide was formed at 90° C. and reduced pressure (25 mbar) over the course of 1 hour. The pressure was equalized with nitrogen and the reaction temperature was increased to 120° C. and a mixture of 1910 g of propylene oxide and 2173 g of ethylene oxide was metered in at a constant rate over the course of 5 hours. After a continued reaction time of 3 hours, the residual monomers were removed under reduced pressure (1 mbar, 60 minutes, 110° C.). Subsequently, the crude product was hydrolysed, neutralized with phosphoric acid and subsequently vacuum-distilled and filtered. The product thus obtained had a hydroxyl number of 202.1 mg KOH/g, a content of primary hydroxyl groups of 36% of the total number of hydroxyl groups and a residual water content of 0.01 wt %, based on the total weight of the product. The ethylene oxide content in the molecule was 53 wt % based on the total alkylene oxide content.

### Example 3 (Noninventive)

A 10 l stirred autoclave was initially charged with 500 g of sorbitol and 30 g of aqueous potassium hydroxide solution (47%), and the alkoxide was formed at 90° C. and reduced pressure (25 mbar) over the course of 1 hour. The pressure was equalized with nitrogen and the reaction temperature was increased to 120° C. and 3820 g of propylene oxide were metered in at a constant rate over the course of 5 hours. After a continued reaction time of 2 hours, the residual monomers were removed under reduced pressure (1 mbar, 30 minutes, 110° C.). Subsequently, the crude product was hydrolysed, neutralized with phosphoric acid and subsequently vacuum-distilled and filtered. The product thus obtained had a hydroxyl number of 214.5 mg KOH/g, a content of primary hydroxyl groups of 0% of the total number of hydroxyl groups and a residual water content of 0.02 wt %, based on the total weight of the product. The ethylene oxide content in the molecule was 0 wt % based on the total alkylene oxide content.

Production of the Polyurethane Foams

In the performance tests, four typical formulations for polyurethane foams of the following compositions were used:

TABLE 2
Formulation I for TDI80 flexible slabstock
foam applications (25 kg/m³)

| Formulation I | Parts by mass (pphp) |
|---|---|
| Arcol ® 1104¹⁾ | 100 − X |
| Desmodur ® T 80²⁾ Index <110> | variable³⁾ |
| Water | 3.8 |
| TEGOAMIN ® B75⁴⁾ | 0.15 |
| KOSMOS ® 29⁵⁾ | 0.18 |
| TEGOSTAB ® B 8158⁶⁾ | 0.8 |
| Foam hardener additive⁷⁾ | X |

¹⁾Available from Bayer MaterialScience; this is a glycerol-based polyether polyol having an OH number of 56 mg of KOH/g.
²⁾T 80 tolylene diisocyanate (80% 2,4-isomer, 20% 2,6-isomer) from Bayer MaterialScience, 3 mPa · s, 48% NCO, functionality 2.
³⁾The amount of TDI has to be adjusted according to the OH number of the foam hardener additive used. However, the TDI index in the case of use of formulation I is always <110>.
⁴⁾Amine catalyst from Evonik Industries AG.
⁵⁾Tin catalyst, available from Evonik Industries AG: tin(II) salt of 2-ethylhexanoic acid.
⁶⁾Polyether-modified polysiloxane, available from Evonik Industries AG.
⁷⁾Foam hardeners used are the inventive additives described in Examples 1 and 2 and the noninventive additive described in Example 3.

TABLE 3
Formulation II for TDI80 flexible slabstock
foam applications (16 kg/m³)

| Formulation II | Parts by mass (pphp) |
|---|---|
| Voranol ® CP 3322⁸⁾ | 100 − X |
| Desmodur ® T 80²⁾ Index <110> | variable³⁾ |
| Water | 5.2 |
| TEGOAMIN ® 33⁴⁾ | 0.15 |
| Methylene chloride | 7.5 |
| KOSMOS ® 29⁵⁾ | 0.25 |
| TEGOSTAB ® B 8158⁶⁾ | 1.3 |
| Foam hardener additive⁷⁾ | X |

²⁾T 80 tolylene diisocyanate (80% 2,4-isomer, 20% 2,6-isomer) from Bayer MaterialScience, 3 mPa · s, 48% NCO, functionality 2.
³⁾The amount of TDI has to be adjusted according to the OH number of the foam hardener additive used. However, the TDI index in the case of use of formulation II is always <110>.
⁴⁾Amine catalyst from Evonik Industries AG.
⁵⁾Tin catalyst, available from Evonik Industries AG: tin(II) salt of 2-ethylhexanoic acid.
⁶⁾Polyether-modified polysiloxane, available from Evonik Industries AG.
⁷⁾Foam hardeners used are the inventive additives described in Examples 1 and 2 and the noninventive additive described in Example 3.
⁸⁾Available from Dow Chemical; this is a glycerol-based polyether polyol having an OH number of 48 mg of KOH/g.

TABLE 4
Formulation III for TDI flexible slabstock foam applications
for examination of the ageing of the foams (16 kg/m³)

| Formulation III | Parts by mass (pphp) |
|---|---|
| Arcol ® 1104¹⁾ | 100 − X |
| Desmodur ® T 80²⁾ Index <115> | variable³⁾ |
| Water | 5 |
| TEGOAMIN ® 33⁴⁾ | 0.13 |
| Methylene chloride | 7.84 |
| KOSMOS ® 29⁵⁾ | variable⁹⁾ |
| TEGOSTAB ® B 8228⁶⁾ | 1.68 |
| Foam hardener additive⁷⁾ | X |

¹⁾Available from Bayer MaterialScience; this is a glycerol-based polyether polyol having an OH number of 56 mg of KOH/g.
²⁾T 80 tolylene diisocyanate (80% 2,4-isomer, 20% 2,6-isomer) from Bayer MaterialScience, 3 mPa · s, 48% NCO, functionality 2.
³⁾The amount of TDI has to be adjusted according to the OH number of the foam hardener additive used. However, the TDI index in the case of use of formulation III is always <115>.
⁴⁾Amine catalyst from Evonik Industries AG.
⁵⁾Tin catalyst, available from Evonik Industries AG: tin(II) salt of 2-ethylhexanoic acid.
⁶⁾Polyether-modified polysiloxane, available from Evonik Industries AG.
⁷⁾Foam hardeners used are the inventive additives described in Examples 1 and 2 and the noninventive additive described in Example 3.
⁹⁾For comparative purposes, foams having comparable hardness and porosity should be produced. In order to be able to produce them with an identical index, the amount of tin catalyst in the individual foaming operations was varied.

TABLE 5
Formulation IV for CO₂-blown TDI80 flexible
slabstock foam applications (18 kg/m³)

| Formulation IV | Parts by mass (pphp) |
|---|---|
| Voranol ® CP 3322⁸⁾ | 100 |
| Desmodur ® T 80²⁾ Index <108> | variable³⁾ |
| Water | 5 |
| TEGOAMIN ® B 75⁴⁾ | 0.11 |
| KOSMOS ® 29⁵⁾ | 0.24 |
| Carbon dioxide | 2.04 |
| TEGOSTAB ® B 8255⁶⁾ | 1.1 |
| Foam hardener additive⁷⁾ | X |

²⁾T 80 tolylene diisocyanate (80% 2,4-isomer, 20% 2,6-isomer) from Bayer MaterialScience, 3 mPa · s, 48% NCO, functionality 2.
³⁾The amount of TDI has to be adjusted according to the OH number of the foam hardener additive used. However, the TDI index in the case of use of formulation IV is always <108>.
⁴⁾Amine catalyst from Evonik Industries AG.
⁵⁾Tin catalyst, available from Evonik Industries AG: tin(II) salt of 2-ethylhexanoic acid.
⁶⁾Polyether-modified polysiloxane, available from Evonik Industries AG.
⁷⁾Foam hardeners used are the inventive additives described in Examples 1 and 2 and the noninventive additive described in Example 3.
⁸⁾Available from Dow Chemical; this is a glycerol-based polyether polyol having an OH number of 48 mg of KOH/g.

General Procedure for Production of the Foams

Polyurethane foams in this study were produced either manually in the laboratory or in batchwise box foaming systems. The foams were produced at 22° C. and air pressure 753 mmHg according to the details which follow. Foams produced according to Formulations I and II were produced by manual foaming operations in the laboratory. Production of each of the polyurethane foams according to Formulation I was accomplished using 400 g of polyol, and production of each of the polyurethane foams according to Formulation II using 200 g of polyol. Polyurethane foams obtained according to Formulation III were produced by batchwise box foaming in a Cofama machine, based on 9 kg of polyol (volume of the foaming box 1 m³). Foams obtained according to Formulation IV were produced by batchwise box foaming in a Hennecke high-pressure machine with NovaFlex® technology. For production of each of the polyurethane foams according to Formulation IV, 500 g of polyol were used; the other formulation constituents were adjusted correspondingly. In this context, for example, 1.0 part (1.0 pphp) of a component meant 1 g of this substance per 100 g of polyol.

For the foams produced manually in the laboratory according to Formulations I and II, a paper cup was initially charged with the tin catalyst tin(II) 2-ethylhexanoate, the polyols, the water, the amine catalysts and the particular additive, and the contents were mixed with a disc stirrer at 1000 rpm for 60 s. Then the isocyanate was added and incorporated using the same stirrer at 2500 rpm for 7 s. In the course of this, the mixture in the cup started to foam. Consequently, directly after the end of stirring, it was poured into a paper-lined foaming box. This has a base area of 30×30 cm and a height of 30 cm. After being poured in, the foam rose up in the foaming box. In the ideal case, the foam blew off on attainment of the maximum rise height and then fell back slightly. At this time, the cell membranes of the foam bubbles opened, and an open-pore cell structure of the foam was obtained.

For the foams produced in the Cofama machine according to Formulation III, the polyols, the water, the amine catalysts and the particular additive were initially charged and mixed with a dissolver disc at 500 rpm for 60 s. Subsequently, the tin catalyst tin(II) 2-ethylhexanoate was added and the mixture was stirred with the same stirrer at 500 rpm for 20 s. The isocyanate was then likewise incorporated with the same stirrer at 500 rpm for 5 s. Via a conical outlet, the reaction mixture was transferred into the foaming box. This has a base area of 1 m×1 m and a height of 1 m. After being poured in, the foam rose up in the foaming box. In the ideal case, the foam blew off on attainment of the maximum rise height and then fell back slightly. At this time, the cell membranes of the foam bubbles opened, and an open-pore cell structure of the foam was obtained.

For the foams produced in the Hennecke Novaflex machine according to Formulation IV, the following parameters were chosen:

| | | |
|---|---|---|
| Output | 4500 | g/min |
| Creamer diameter | 40 | mm |
| Nitrogen | 20 1 | (STP)/min |
| Mixing chamber pressure | 6 | bar |

| Sieve package | Openness [%] | Hole size [μ] |
|---|---|---|
| Preliminary sieve | 16 | 85 |
| Main sieve 1 | 3.5 | 100 |
| Main sieve 2 | 2 | 100 |
| Concluding sieve | 23 | 100 |

Performance Tests

The foams produced were rated on the basis of the following physical properties:
a) Foam settling after the end of the rise phase (=fall-back):
   The fall-back, or the further rise, is found from the difference in the foam height after direct blow-off and after 3 minutes after foam blow-off. The foam height is measured at the maximum in the middle of the foam crest by means of a needle secured to a centimetre scale. A negative value here describes the settling of the foam after blow-off; a positive value correspondingly describes the further rise of the foam.
b) Foam height is the height of the freely risen foam formed after 3 minutes. Foam height is reported in centimetres (cm).
c) Rise time
   The period of time between the end of mixing of the reaction components and the blow-off of the polyurethane foam.
d) Foam density
   The determination is effected as described in DIN EN ISO 845:2009-10 by measuring the apparent density. Foam density is reported in kg/m³.
e) Porosity
   The air permeability of the foam was determined in accordance with DIN EN ISO 4638:1993-07 by a dynamic pressure measurement on the foam. The dynamic pressure measured was reported in mm water column, with the lower dynamic pressure values then characterizing the more open foam. The values were measured in the range from 0 to 300 mm.
   The dynamic pressure was measured by means of an apparatus comprising a nitrogen source, a reducing valve with manometer, a screw-thread flow regulator, a wash bottle, a flow meter, a T-piece, an applicator nozzle and a scaled glass tube filled with water. The applicator nozzle has an edge length of 100×100 mm, a weight of 800 g, a clear width of 5 mm for the outlet hole, a clear width of 20 mm for the lower applicator ring and an outer diameter of 30 mm for the lower applicator ring.
   The measurement is effected by adjusting the nitrogen supply pressure to 1 bar with the reducing valve and adjusting the flow rate to 480 l/h. The amount of water in the scaled glass tube is adjusted such that no pressure differential is built up and none can be read off. For the analysis of the test specimen having dimensions of 250×250×50 mm, the applicator nozzle is placed onto the corners of the test specimen, flush with the edges, and once onto the (estimated) middle of the test specimen (in each case on the side with the greatest surface area). The result is read off when a constant dynamic pressure has been established.
   Evaluation is effected by forming the average of the five measurements obtained.
f) Number of cells per cm (cell count): This is determined visually on a cut surface (measured to DIN EN 15702).
g) Hardness
   1) As compressive strength CLD 40% to DIN EN ISO 3386-1:1997+A1:2010. The measured values are reported in kilopascals (kPa).
   2) As indentation hardness to DIN EN ISO 2439:2008. The measured values are reported in newtons (N).
h) Tensile strength and elongation at break to DIN EN ISO 1798:2008. The measurements of tensile strength are reported in kilopascals (kPa), and those of elongation at break in percent (%).
i) Rebound resilience to DIN EN ISO 8307:2007. The measurements are reported in percent (%).

Examination of the Ageing Properties of the Polyurethane Foams Produced

In order to examine the ageing properties of the foams produced, polyurethane foams which had been manufactured according to Formulation III using 9 kg of polyol in a batchwise box foaming operation were compared. This was done by comparing foams which contained either one of the two inventive additives (prepared according to Examples 1 and 2) or the noninventive additive (prepared according to Example 3) or, as a reference, did not contain any foam hardener additive at all. The foams should all be produced with the same index (TDI index <115>) and have a comparable indentation hardnesses (determinable to DIN EN ISO 2439:2008) and comparable air permeability (determined in accordance with DIN EN ISO 4638:1993-07 by a backpressure measurement). In order to achieve this, the amount of tin catalyst in the individual foaming operations was varied. The reference foam without foam hardener additive was produced with 0.28 pphp of KOSMOS® 29 (tin catalyst, available from Evonik Industries AG: tin(II) salt of 2-ethylhexanoic acid), whereas the foams which contained 3 pphp of the inventive foam hardener additives according to Examples 1 and 2 were produced with an amount of 0.22 pphp of KOSMOS® 29. The foam which had been produced with 3 parts of the noninventive additive according to Example 3 contained only 0.18 pphp of KOSMOS® 29.

To examine the ageing properties, a method based on ISO 3385-1975 was developed and implemented. For this purpose, a foam specimen of size 380 mm×380 mm×50 mm was compressed 80 000 times down to 70% of its original height and released again at a frequency of 70 cycles per minute. Subsequently, the loss of foam thickness and the loss of indentation hardness were determined.

Results of the Foaming Operations

The inventive additives of Examples 1 and 2 and the noninventive additive described in Example 3 were tested in Formulations I-IV. The foams produced in Formulations I, II and IV were each produced with 3 pphp and with 5 pphp of the foam hardener additive and compared with reference foams which did not contain any foam hardener additive. The foams which had been produced according to Formulation III for testing of the ageing properties contained only 3 pphp of the foam hardener additive and were compared with a reference foam which did not contain any foam hardener additive. The results of the performance tests for the various formulations and the additives used are shown in Tables 1 to 4.

TABLE 6
Foaming results with use of various foam hardener additives according to Formulation I

| | | | | | | | | | | | Compressive | Increase in | |
|---|---|---|---|---|---|---|---|---|---|---|---|---|---|
| | | Amount used | | Rise | Rise | | Cell | | Tensile | Ball | strength | compressive | |
| | | [pphp] | | time | height | Fall-back | count | Density | strength | rebound | (CLD 40%) | strength | Porosity |
| No. | Additive | Additive | Polyol | [s] | [cm] | [cm] | [cm⁻¹] | [kg/m³] | [kPa] | [%] | [kPa] | [%] | [mm] |
| 1 | Reference | 0 | 100 | 107 | 32.5 | 0.5 | 12 | 24.3 | 84.0 | 33 | 3.5 | — | 13 |
| 2 | Ex. 1 ^{a)} | 3 | 97 | 107 | 32.4 | 0.5 | 12 | 24.4 | 87.5 | 31 | 4.4 | 25 | 19 |
| 3 | Ex. 1 ^{a)} | 5 | 95 | 105 | 32.4 | 0.4 | 12 | 24.6 | 85.3 | 25 | 4.7 | 34 | 33 |
| 4 | Ex. 2 ^{a)} | 3 | 97 | 108 | 32.4 | 0.3 | 12 | 24.6 | 86.4 | 34 | 4.5 | 28 | 24 |
| 5 | Ex. 2 ^{a)} | 5 | 95 | 110 | 32.6 | 0.4 | 12 | 24.5 | 84.7 | 30 | 4.8 | 37 | 42 |
| 6 | Ex. 3 ^{b)} | 3 | 97 | 129 | 32.7 | 0.2 | 12 | 24.1 | 85.9 | 28 | 4.5 | 28 | >300 |
| 7 | Ex. 3 ^{b)} | 5 | 95 | 153^{c)} | n.d. | ad. | n.d. | ad. | ad. | ad. | ad. | ad. | n.d. |

^{a)} inventive additives, prepared according to Examples 1-2
^{b)} noninventive additive, prepared according to Example 3
^{c)}The foam rises up and does not blow off. Instead, the foam continues to rise for a long period (>2.5 min). In the course of subsequent cooling, the foam shrinks significantly. It was not possible to conduct a measurement of the physical properties because of the shrinkage.

TABLE 7
Foaming results with use of various foam hardener additives according to Formulation II

| | | | | | | | | | | | Compressive | Increase in | |
|---|---|---|---|---|---|---|---|---|---|---|---|---|---|
| | | Amount used | | Rise | Rise | | Cell | | Tensile | Ball | strength | compressive | |
| | | [pphp] | | time | height | Fall-back | count | Density | strength | rebound | (CLD 40%) | strength | Porosity |
| No. | Additive | Additive | Polyol | [s] | [cm] | [cm] | [cm−1] | [kg/m³] | [kPa] | [%] | [kPa] | [%] | [mm] |
| 8 | Reference | 0 | 100 | 85 | 24.6 | 0.2 | 12 | 15.9 | 74.6 | 30 | 2.5 | — | 23 |
| 9 | Ex. 1 a) | 3 | 97 | 99 | 24.4 | 0.3 | 12 | 16.0 | 80.3 | 29 | 3.1 | 24 | 30 |
| 10 | Ex. 1 a) | 5 | 95 | 107 | 24.3 | 0.3 | 12 | 16.0 | 80.0 | 24 | 3.4 | 36 | 74 |
| 11 | Ex. 2 a) | 3 | 97 | 100 | 24.3 | 0.3 | 12 | 15.9 | 75.6 | 30 | 3.1 | 24 | 35 |
| 12 | Ex. 2 a) | 5 | 95 | 103 | 24.4 | 0.2 | 12 | 15.9 | 80.3 | 28 | 3.5 | 40 | 75 |
| 13 | Ex. 3 b) | 3 | 97 | 122 | 24.6 | 0.1 | 12 | 15.7 | 80.1 | 25 | 3.1 | 24 | >300 |
| 14 | Ex. 3 b) | 5 | 95 | 130 | 24.7 | 0.1 | 12 | 15.6 | 81.2 | 25 | 3.5 | 40 | >300 |

a) inventive additives, prepared according to Examples 1-2
b) noninventive additive, prepared according to Example 3

As shown in Table 6, formulation I (density 25 kg/m³) without foam hardener additive gave a foam which had a compressive strength at 40% compression of 3.5 kPa (reference foam, entry 1, Table 6). With an air permeability of 13 mm water column, a very open cell structure was also obtained. After addition of 3 pphp of the inventive additive prepared analogously to Example 1, a foam which had a compressive strength at 40% compression of 4.4 kPa was obtained (entry 2, Table 6). This corresponds to an increase in hardness of 25%. On addition of 5 pphp of the additive according to Example 1, an increase in hardness of 34% was achieved (4.7 kPa, entry 3, Table 6). In both cases, very open-cell pore structures were likewise obtained (19 mm H₂O, entry 2 and 33 mm H₂O, entry 3). In the case of use of 3 pphp of the inventive additive prepared according to Example 2, an open-cell flexible slabstock foam (24 mm H₂O) with a compressive strength of 4.5 kPa was obtained (entry 4, Table 6), which corresponds to an increase in hardness of 28%, compared to the reference foam without foam hardener additive. With 5 pphp of the additive according to Example 2, an increase in hardness of 37% was achieved (4.8 kPa, porosity 42 mm H₂O, entry 5, Table 6). In the case of use of 3 pphp of the noninventive foam hardener additive which was synthesized according to Example 3, an increase in hardness was also obtained compared to the reference foam (4.5 kPa, 28% increase, entry 6, Table 6), but a non-open-cell foam structure was obtained (porosity >300 mm water column). After use of 5 pphp, the foam obtained actually had such an extent of closed cells that only shrinkage was obtained after cooling. Therefore, evaluation of the other physical data was impossible.

It is apparent from Table 7 that foams which have been produced according to Formulation II (density 16 kg/m³) without foam hardener additive have a compressive strength at 40% compression of 2.5 kPa (reference foam, entry 8, Table 7). With an air permeability of 23 mm water column, a very open cell structure was also obtained. After addition of 3 pphp of the inventive additive prepared analogously to Example 1, a foam which had a compressive strength at 40% compression of 3.1 kPa was obtained (entry 9, Table 7). This corresponds to an increase in hardness of 24%. On addition of 5 pphp of the additive according to Example 1, an increase in hardness of 36% was achieved (3.4 kPa, entry 10, Table 7). In both cases, moreover, open-cell pore structures were likewise obtained (30 mm H₂O, entry 9 and 74 mm H₂O, entry 10). In the case of use of 3 pphp of the inventive additive prepared according to Example 2, an open-cell flexible slabstock foam (35 mm H₂O) with a compressive strength of 3.1 kPa was obtained (entry 11, Table 7), which corresponds to an increase in hardness of 24%, compared to the reference foam without foam hardener additive. With 5 pphp of the additive according to Example 2, an increase in hardness of 40% was achieved (3.5 kPa, porosity 75 mm H₂O, entry 12, Table 7). In the case of use of 3 pphp or 5 pphp of the noninventive foam hardener additive which was synthesized according to Example 3, an increase in hardness was also obtained compared to the reference foam (3.1 kPa, 24% increase, entry 13, Table 7 and 3.5 kPa, 40% increase, entry 14, Table 7), but a non-open-cell foam structure was obtained (porosity in each case >300 mm water column).

It was thus possible to show that a significant increase in hardness was achievable with the inventive additives prepared according to Examples 1 and 2 in Formulations I and II compared to the reference foam without foam hardener additive. In all cases, it was also possible to obtain sufficiently open cell structures. With the noninventive additive which was prepared according to Example 3, it was likewise possible to achieve an increase in hardness compared to the reference, but it was found that a very closed pore structure was obtained in all cases.

It becomes clear from Table 8 that foams which have been produced with the inventive additives (prepared analogously to Example 1 or 2) according to Formulation III (entries 16 and 17, Table 8) have better ageing properties than the reference foam without foam hardener additive (entry 15, Table 8) or the foam which has been produced with 3 parts of the noninventive additive according to Example 3 (entry 18, Table 8). In order to achieve good comparability, all the foams tested should have both comparable compressive strength and comparable air permeability. In order to achieve this, the amount of tin catalyst in the individual foaming operations was varied. The reference foam without foam hardener additive was produced with 0.28 pphp of KOSMOS® 29 (tin catalyst, available from Evonik Industries AG: tin(II) salt of 2-ethylhexanoic acid) (indentation hardness (ILD 40%) 110 N, air permeability 49 mm H₂O, entry 15, Table 8), whereas the foams which contained 3 pphp of the inventive foam hardener additives according to Examples 1 and 2 were produced with an amount of 0.22 pphp of KOSMOS® 29 (indentation hardness (ILD 40%) 113 N in each case, air permeability 43 and 44 mm H₂O respectively, entries 16 and 17, Table 8). The foam which had been produced with 3 parts of the noninventive additive according to Example 3 contained only 0.18 pphp of KOSMOS® 29 (indentation hardness (ILD 40%) 115 N, air permeability 48 mm H₂O, entry 18, Table 8).

Subsequently, the foams obtained, to examine the ageing properties, were subjected to an ageing test in accordance with ISO 3385-1975. For this purpose, a foam specimen of size 380 mm×380 mm×50 mm was compressed 80 000 times down to 70% of its original height and released again at a frequency of 70 cycles per minute. Subsequently, the loss of foam thickness and the loss of indentation hardness were determined. The improved ageing properties of the foams which have been produced with the inventive additives were found especially in the smaller loss of hardness after 80 000 compressions. Thus, it was possible to determine a loss of indentation hardnesses after 40% compression of 16.2% and 15.8% respectively in the case of the inventive additives (entries 16 and 17, Table 8), whereas the reference had a loss of indentation hardness of 24.6% (entry 15, Table 8). The foam which had been obtained with 3 parts of the noninventive additive synthesized according to Example 3 had a loss of indentation hardness of 25.6% after 80 000 compressions to 40% of the original height (entry 18, Table 8).

Table 9 shows that a significant increase in hardness can also be achieved with carbon dioxide as physical blowing agent (Formulation IV, density 18 kg/m³) by using the inventive additives, with only marginal impairment of the air permeability of the foams obtained. Foams which had been produced without foam hardener additive had a compressive strength at 40% compression of 2.0 kPa (reference foam, entry 19, Table 9). With an air permeability of 11 mm water column, a very open cell structure was also obtained. After addition of 3 pphp of the inventive additive prepared analogously to Example 1, a foam which had a compressive strength at 40% compression of 2.4 kPa was obtained (entry 20, Table 9). This corresponds to an increase in hardness of 20%. On addition of 5 pphp of the additive according to Example 1, an increase in hardness of 30% was achieved (2.6 kPa, entry 21, Table 9). In both cases, moreover, open-cell pore structures were likewise obtained (23 mm H₂O, entry 20 and 45 mm H₂O, entry 21). In the case of use of 3 pphp of the inventive additive prepared according to Example 2, an open-cell flexible slabstock foam (30 mm H₂O) with a compressive strength of 2.5 kPa was obtained (entry 22, Table 9), which corresponds to an increase in hardness of 25%, compared to the reference foam without foam hardener additive. With 5 pphp of the additive according to Example 2, an increase in hardness of 30% was achieved (2.6 kPa, porosity 49 mm H₂O, entry 23, Table 9). In the case of use of 3 pphp or 5 pphp of the noninventive foam hardener additive which was synthesized according to Example 3, an increase in hardness was also obtained compared to the reference foam (2.4 kPa, 20% increase, entry 24, Table 9 and 2.6 kPa, 30% increase, entry 25, Table 9), but a non-open-cell foam structure was obtained (porosity in each case >300 mm water column).

TABLE 8
Foaming results after with use of different foam hardener additives according to Formulation III
and results of the examination of the ageing properties in accordance with ISO 3385-1975 (E)

| | | | | | | | Loss of | |
|---|---|---|---|---|---|---|---|---|
| | | Amount used [pphp] | | | Indentation hardness | Porosity | indentation | Loss of foam |
| No. | Additive | Additive | Polyol | KOSMOS ® 29 | (ILD 40%, 24 h) [N] | [mm] | hardness [%] | thickness [%] |
| 15 | Reference | 0 | 100 | 0.28 | 110 | 49 | 24.6 | 2.0 |
| 16 | Ex. 1 ^{a)} | 3 | 97 | 0.22 | 113 | 43 | 16.2 | 2.0 |
| 17 | Ex. 2 ^{a)} | 3 | 97 | 0.22 | 113 | 44 | 15.8 | 1.8 |
| 18 | Ex. 3 ^{b)} | 3 | 97 | 0.18 | 115 | 48 | 25.9 | 2.4 |

^{a)} inventive additives, prepared according to Examples 1-2
^{b)} noninventive additive, prepared according to Example 3

TABLE 9
Foaming results with use of various foam hardener additives according to Formulation IV

| | | Amount used | | Rise | | Cell | | Compressive | Increase in | |
|---|---|---|---|---|---|---|---|---|---|---|
| | | [pphp] | | time | Fall-back | count | Density | strength (CLD | compressive | Porosity |
| No. | Additive | Additive | Polyol | [s] | [cm] | [cm⁻¹] | [kg/m³] | 40%) [kPa] | strength [%] | [mm] |
| 19 | Reference | 0 | 100 | 100 | 0.2 | 11 | 17.5 | 2.0 | — | 11 |
| 20 | Ex. 1 ^{a)} | 3 | 100 | 99 | 0.3 | 11 | 17.7 | 2.4 | 20 | 23 |
| 21 | Ex. 1 ^{a)} | 5 | 100 | 100 | 0.3 | 11 | 17.8 | 2.6 | 30 | 45 |
| 22 | Ex. 2 ^{a)} | 3 | 100 | 102 | 0.2 | 11 | 17.8 | 2.5 | 25 | 30 |
| 23 | Ex. 2 ^{a)} | 5 | 100 | 101 | 0.2 | 11 | 17.7 | 2.6 | 30 | 49 |
| 24 | Ex. 3 ^{b)} | 3 | 100 | 122 | 0.1 | 11 | 17.5 | 2.4 | 20 | >300 |
| 25 | Ex. 3 ^{b)} | 5 | 100 | 128 | 0.0 | 11 | 17.3 | 2.6 | 30 | >300 |

^{a)} inventive additives, prepared according to Examples 1-2
^{b)} noninventive additive, prepared according to Example 3

1. An additive suitable for increasing hardness in the production of flexible polyurethane foam, the additive comprising at least one compound (V) having
(i) more than three hydrogen atoms reactive toward isocyanates and
(ii) having an average hydroxyl number, determined to DIN 53240-1:2013-06, of 110-280 mg KOH/g, and
(iii) containing >50 wt % of ethylene oxide bound within the molecule, wt % based on the total alkylene oxide content of the compound (V).

2. The additive according to claim 1, wherein the compound (V) has a functionality of 4 to 10.

3. The additive according to claim 1, wherein the ethylene oxide bound within the molecule is in a terminal position, at least to an extent of ≥50%, % based on the total amount of ethylene oxide bound within the molecule.

4. The additive according to claim 1, wherein it is a liquid at room temperature and atmospheric pressure.

5. The additive according to claim 1, wherein the compound (V) of the invention is selected from compounds of the formula (I) 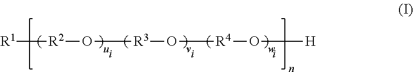
in which
R¹=starter substance radical minus the hydrogen atoms active for the alkoxylation, such as preferably molecular residues of polyhydric alcohols, polyfunctional amines, polyhydric thiols, carboxylic acids, amino alcohols, aminocarboxylic acids, thio alcohols, hydroxyl esters, polyether polyols, polyester polyols, polyester ether polyols, polycarbonate polyols, polyethyleneimines, polyether amines, polyether thiols, polyacrylate polyols, castor oil, of mono-, di- or triglycerides of ricinoleic acid, chemically modified mono-, di- and/or triglycerides of fatty acids and/or C1-C24 alkyl fatty acid esters containing an average of at least 3 OH groups per molecule,
R² is CH₂—CH(CH₃),
R³ is CH₂—CH₂,
R⁴ is CH₂—CH(R⁵), CH(R⁶)—CH(R⁶), CH₂—C(R⁶)₂, C(R⁶)₂—C(R⁶)₂, 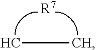
CH₂—CH—CH₂—R⁸, C₆H₆—CH—CH₂, C₆H₆—C(CH₃)—CH₂,
molecular residue of mono- or polyepoxidized fats or oils as mono-, di- and triglycerides or molecular residue of mono- or polyepoxidized fatty acids or the C₁-C₂₄-alkyl esters thereof,
R⁵ is a C₂ to C₂₄ alkyl radical or alkene radical, which may be linear or branched,
R⁶ is a C₂ to C₂₄ alkyl radical or alkene radical, which may be linear or branched,
R⁷ is a C₃ to C₆ alkyl radical in linear arrangement,
R⁸ is OH, Cl, OCH₃, OCH₂—CH₃, O—CH₂—CH═CH₂, O—CH═CH₂,
and where
uᵢ≥0,
vᵢ≥1,
wᵢ is integers of 0-400,
n is an integer of 4 to 25,
i is an integer with i=1 to n,
where the sequence of the monomer units in the individual polymer chains 1 to n is arbitrary, and where the compositions of the n-polymer chains may be independent of one another.

6. The additive according to claim 1, wherein the compounds (V) present contain 51 to 100 wt % of ethylene oxide and 0 to 49 wt %, wt % based on the total alkylene oxide content of the compound (V) as per formula (I).

7. A process for producing polyurethane foams and flexible polyurethane foams, the process comprising the steps of reacting
(a) one or more polyol components with
(b) one or more isocyanate components,
in the presence of
(c) an additive,
(d) catalysts,
(e) water and optionally organic blowing agents, preferably carbon dioxide and/or methylene chloride,
(g) stabilizers and optionally emulsifiers and
(f) optionally other additives,
wherein the additive used is an additive composition according to claim 1, comprising at least one compound (V).

8. The process according to claim 7, characterized in that 0.1 to 10 parts by weight, of compounds (V) are used per 100 parts of the total amount of polyol used.

9. The process according to claim 7 for production of flexible polyurethane foams having
a gas permeability (A) of 1 to 300 mm water column and preferably 3 to 250 mm water column,
a density (B) preferably of 5 to 150 kg/m³, more preferably of 10 to 130 kg/m³ and especially preferably of 15 to 100 kg/m³,
a pore structure (C) preferably having 5 to 25 cells/cm,
a compressive strength (D) of 0.1 kPa to 15 kPa, preferably 0.5 to 13 kPa and especially preferably 2 to 11 kPa, and
preferably a cell structure (E) having an open-cell content of more than 80%, (A) to (E) each measured as specified in the description.

10. The process according to claim 7, wherein the isocyanate used is toluene 2,4-diisocyanate as an isomer mixture, especially as a mixture of 80% toluene 2,4-diisocyanate and 20% toluene 2,6-diisocyanate.

11. A polyurethane foam obtainable by a process of claim 7, wherein the polyurethane foam is preferably a flexible polyurethane foam, a moulded polyurethane foam or a free-rise flexible slabstock polyurethane foam.

12. The polyurethane foam according to claim 11, having
a gas permeability (A) of 1 to 300 mm water column,
a density (B) preferably of 5 to 150 kg/m³,
a pore structure (C) having 5 to 25 cells/cm,
a compressive strength (D) of 0.1 kPa to 15 kPa, and
a cell structure (E) having an open-cell content of more than 80%, (A) to (E) each measured as specified in the description.

13. Use of the polyurethane foam according to claim 11 as packaging foam, mattress, furniture cushioning, material in motor vehicle interiors, automobile seat cushioning, headrest, automobile interior trim, sound absorption material, shoe sole, foam for brassieres, carpet backing foam, filter foam, or for production of corresponding products, especially as material in motor vehicle interiors.

14. Use of an additive according to claim 1 for improving the hardness of flexible polyurethane foam with retention of an adequate open-cell content, especially with avoidance of a reduction in the TDI index or in the amounts of catalyst, and/or for improving the ageing properties of flexible polyurethane foam in the course of foam production in each case.

15. An activator solution suitable for production of flexible polyurethane foam, comprising additive according to claim 1, and stabilizers, catalysts, blowing agents, such as particularly water, and optionally further additives, such as particularly flame retardants, antioxidants, UV stabilizers, dyes, biocides, pigments, cell openers and/or crosslinkers, wherein the activated solution is free of isocyanates and polyols other than the compound (V).

16. The additive according to claim 1, wherein the compound (V) has a functionality of 4 to 8 and an average hydroxyl number, determined to DIN 53240-1:2013-06, of 120-250 mg KOH/g.

17. The additive according to claim 1, wherein the ethylene oxide bound within the molecule is in a terminal position in the form of blocks, at least to an extent of ≥90%, the % based on the total amount of ethylene oxide bound within the molecule.

18. The additive according to claim 5, wherein
uᵢ≥1,
wᵢ is 0, and
n is an integer of 4 to 8.

19. The additive according to claim 1, wherein the compounds (V) present contain 60 to 85 wt % of ethylene oxide and 15 to 40 wt %, wt % based on the total alkylene oxide content of the compound (V) as per formula (I).

20. The process according to claim 7, wherein 0.5 to 8 parts by weight of compounds (V) are used per 100 parts of the total amount of polyol used.
